(19) United States
(12) Patent Application Publication
(10) Pub. No.: US 2020/0044600 A1
(43) Pub. Date: Feb. 6, 2020

(54) SELF-CLEANING SOLAR PANEL ASSEMBLY AND SPRINKLER MOUNTING ASSEMBLY THEREFOR

(71) Applicant: NAANDANJAIN IRRIGATION LTD., Kibbutz Naan (IL)

(72) Inventors: Lior Eliahu MARELI, Rehovot (IL); Oleg GLEZERMAN, Maalot (IL)

(73) Assignee: NAANDANJAIN IRRIGATION LTD., Kibbutz Naan (IL)

(21) Appl. No.: 16/489,821

(22) PCT Filed: Jan. 24, 2018
(86) PCT No.: PCT/IL2018/050088

§ 371 Date: Aug. 29, 2019

Related U.S. Application Data
(60) Provisional application No. 62/470,512, filed on Mar. 13, 2017.

(51) Int. Cl. H02S 40/10; H02S 30/10; B08B 3/02

(52) U.S. Cl. CPC H02S 40/10; B08B 3/02; H02S 30/10

(57) ABSTRACT

A self-cleaning solar panel assembly including a solar panel assembly having a peripheral frame, at least one sprayer mount assembly removably attachable to the peripheral frame, each of the at least one sprayer mount including a first element and a second element, both separate from the peripheral frame, the first element and the second element being removably joined together for clamping onto the peripheral frame and at least one sprayer mountable onto the at least one sprayer mount assembly.

### REFERENCE TO RELATED APPLICATIONS

Reference is hereby made to U.S. Provisional Patent Application Ser. No. 62/470,512, filed Mar. 13, 2017, entitled: SELF-CLEANING SOLAR PANEL ASSEMBLY AND SPRINKLER MOUNTING ASSEMBLY THEREFOR, the disclosure of which is hereby incorporated by reference and priority of which is hereby claimed pursuant to 37 CFR 1.78(a).

### FIELD OF THE INVENTION

The present invention relates to self-cleaning solar panel assemblies and sprayer assemblies therefor and more particularly to retrofittable sprayer systems and sprayer mounting systems for use with solar panel assemblies.

### BACKGROUND OF THE INVENTION

Various types of sprayer assemblies are currently in use with solar panel assemblies.

### SUMMARY OF THE INVENTION

The present invention seeks to provide improved self-cleaning solar panel assemblies and sprayer assemblies therefor.

There is thus provided in accordance with a preferred embodiment of the present invention a self-cleaning solar panel assembly including a solar panel assembly having a peripheral frame, at least one sprayer mount assembly removably attachable to the peripheral frame, each of the at least one sprayer mount including a first element and a second element, both separate from the peripheral frame, the first element and the second element being removably joined together for clamping onto the peripheral frame and at least one sprayer mountable onto the at least one sprayer mount assembly.

In accordance with a preferred embodiment of the present invention the at least one sprayer mount assembly is retrofittable onto the solar panel assembly.

Preferably, the at least one sprayer is adapted to receive a cleaning liquid via a supply hose from a cleaning liquid manifold, which in turn is preferably mounted onto plural ones of the sprayer mount assemblies.

In accordance with a preferred embodiment of the present invention the first element includes a partially folded-over portion which defines a slot removably but snugly receiving an inner-facing flange of the peripheral frame. Additionally, the slot includes an end wall, which engages an inner-facing edge of the inner-facing flange of the peripheral frame.

Preferably, the first element includes a pair of flexible ratcheted arms and a central support and guiding finger for adjustable engagement with the second element thereby to accommodate various sizes of the peripheral frame. Additionally, each of the flexible ratcheted arms is manually squeezable towards each other for enabling manual disengagement of the first and second elements from each other and from the peripheral frame.

In accordance with a preferred embodiment of the present invention the second element includes a main generally planar portion and a secondary generally planar portion extending generally perpendicularly thereto, the main generally planar portion including a pair of mutually spaced apertures each of which is formed with a tooth engagement wall portion, for engagement with ratchet teeth of the ratcheted arms of the first element and a main aperture which is configured to slidably receive the central support and guiding finger of the first element. Additionally, the main generally planar portion is formed with a pair of resilient fingers, which provide press fit engagement with a peripheral wall portion of the peripheral frame.

In accordance with a preferred embodiment of the present invention the main generally planar portion is formed with an upstanding sprayer mounting pin for mounting of the sprayer.

There is also provided in accordance with another preferred embodiment of the present invention a self-cleaning solar panel assembly including a solar panel assembly having a peripheral frame, at least one retrofit sprayer mount removably attachable to the peripheral frame, each of the at least one retrofit sprayer mount including a frame engagement portion and a sprayer mounting portion, separate from the frame engagement portion, the frame engagement portion being arranged for removable frictional engagement with the peripheral frame and at least one sprayer mountable onto the at least one retrofit sprayer mount assembly.

There is further provided in accordance with yet another preferred embodiment of the present invention a self-cleaning solar panel assembly including a solar panel assembly having a peripheral frame, at least one retrofit sprayer mount removably attachable to the peripheral frame, each of the at least one retrofit sprayer mount including a frame engagement portion and a sprayer mounting portion, separate from the frame engagement portion, the frame engagement portion and the sprayer mounting portion being arranged for secure clamping onto the peripheral frame and at least one sprayer mountable onto the at least one retrofit sprayer mount assembly.

There is yet further provided in accordance with still another preferred embodiment of the present invention, for use with a solar panel assembly having a peripheral frame, a sprayer mount assembly including a frame engagement portion and a sprayer mounting portion, separate from the frame engagement portion, the frame engagement portion and the sprayer mounting portion being removably joinable together for clamping onto the peripheral frame.

There is even further provided in accordance with yet another preferred embodiment of the present invention, for use with a solar panel assembly having a peripheral frame, a sprayer mount assembly including a frame engagement portion and a sprayer mounting portion, separate from the frame engagement portion, the frame engagement portion and the sprayer mounting portion being arranged for removable frictional engagement with the peripheral frame.

There is still further provided in accordance with another preferred embodiment of the present invention, for use with a solar panel assembly having a peripheral frame, a sprayer mount assembly including a frame engagement portion, and a sprayer mounting portion, separate from the frame engagement portion, the frame engagement portion and the sprayer mounting portion being arranged for secure clamping onto the peripheral frame. There is also provided in accordance with yet another preferred embodiment of the present invention, for use with a solar panel assembly having a peripheral frame, a sprayer and sprayer mount assembly including: a frame engagement portion a sprayer mounting portion, separate from the frame engagement portion, the frame engagement portion and the sprayer mounting portion being removably joinable together for clamping onto the peripheral frame and a static sprayer mounted onto the sprayer mounting portion.

There is further provided in accordance with still another preferred embodiment of the present invention, for use with a solar panel assembly having a peripheral frame, a sprayer and sprayer mount assembly including a frame engagement portion, a sprayer mounting portion, separate from the frame engagement portion, the frame engagement portion and the sprayer mounting portion being arranged for removable frictional engagement with the peripheral frame and a static sprayer mounted onto the sprayer mounting portion.

There is yet further provided in accordance with yet another preferred embodiment of the present invention, for use with a solar panel assembly having a peripheral frame, a sprayer and sprayer mount assembly including a frame engagement portion, a sprayer mounting portion, separate from the frame engagement portion, the frame engagement portion and the sprayer mounting portion being arranged for secure clamping onto the peripheral frame and a static sprayer mounted onto the sprayer mounting portion.

In accordance with a preferred embodiment of the present invention the frame engagement portion and the sprayer mounting portion are selectably positionable for clamping onto the peripheral frame.

Preferably, the at least one sprayer is adapted to receive a cleaning liquid via a supply hose from a cleaning liquid manifold, which in turn is preferably mounted onto plural ones of the sprayer mount assemblies.

In accordance with a preferred embodiment of the present invention the frame engagement portion includes a partially folded-over portion which defines a slot removably but snugly receiving an inner-facing flange of the peripheral frame. Additionally, the slot includes an end wall, which engages an inner-facing edge of an inner-facing flange of the peripheral frame.

In accordance with a preferred embodiment of the present invention the frame engagement portion includes a pair of flexible ratcheted arms and a central support and guiding finger for adjustable engagement with the sprayer mounting portion thereby to accommodate various sizes of the peripheral frame. Additionally, each of the flexible ratcheted arms is manually squeezable towards each other for enabling manual disengagement of the frame engagement portion and the sprayer mounting portion from each other and from the peripheral frame.

Preferably, the sprayer mounting portion includes a main generally planar portion and a secondary generally planar portion extending generally perpendicularly thereto, the main generally planar portion including a pair of mutually spaced apertures each of which is formed with a tooth engagement wall portion, for engagement with ratchet teeth of the ratcheted arms of the frame engagement portion and a main aperture which is configured to slidably receive a central support and guiding finger of the frame engagement portion. Additionally, the main generally planar portion is formed with at least one resilient finger, which provides press fit engagement with a peripheral wall portion of the peripheral frame.

In accordance with a preferred embodiment of the present invention the main generally planar portion is formed with an upstanding sprayer mounting pin for mounting of the sprayer.

### BRIEF DESCRIPTION OF THE DRAWINGS

The present invention will be understood and appreciated more fully from the following detailed description, taken in conjunction the drawings in which:

FIGS. 1A, 1B and 1C are, respectively, a simplified front pictorial illustration and two simplified back view pictorial illustrations of a self-cleaning solar panel assembly constructed and operative in accordance with a preferred embodiment of the present invention;

FIGS. 1D, 1E and 1F are, respectively, simplified enlargements of details of the assembly shown in FIGS. 1A and 1C, the details being respectively indicated by letters D, E and F in FIGS. 1A and 1C;

FIG. 2 is a simplified exploded view illustration of a sprayer and sprayer mount assembly shown as part of the self-cleaning solar panel assembly of FIGS. 1A-1F;

FIGS. 3A, 3B, 3C, 3D, 3E and 3F are simplified respective pictorial, top planar, bottom planar, first and second end view and side view illustrations of a first bracket element forming part of the sprayer mount assembly of FIG. 2;

FIGS. 3G, 3H, 3I, 3J, 3K, 3L and 3M are respective simplified sectional illustrations taken along respective lines G-G, H-H, I-I, J-J, K-K, L-L and M-M in FIGS. 3B, 3C and 3F;

FIGS. 4A, 4B, 4C, 4D, 4E and 4F are simplified respective pictorial, front planar, first side planar, second side planar, top planar and bottom planar illustrations of a second bracket element forming part of the sprayer mount assembly of FIG. 2;

FIGS. 4G, 4H, 4I, 4J and 4K are respective simplified sectional illustrations taken along respective lines G-G, H-H, I-I, J-J and K-K in FIGS. 4B and 4C;

FIGS. 5A and 5B are simplified respective pictorial and side view illustrations of a pre-mounting stage in the mounting of the first bracket element onto a portion of a conventional solar panel, which is shown partially in section;

FIGS. 6A and 6B are simplified respective pictorial and side view illustrations of a fully mounted stage in the mounting of the first bracket element onto a portion of a conventional solar panel, which is shown partially in section;

FIGS. 6C and 6D are simplified respective planar top view and bottom view of the fully mounted stage in the mounting of the first bracket element onto a portion of a conventional solar panel;

FIG. 7 is a simplified pictorial illustration of a pre-mounting stage in the mounting of the second bracket element onto the first bracket element in engagement with a portion of a conventional solar panel, which is shown partially in section;

FIGS. 8A, 8B, 8C and 8D are simplified respective pictorial, planar top view, planar bottom view and side view illustrations of an initial mounting stage in the mounting of the second bracket element onto the first bracket element in engagement with a portion of a conventional solar panel, which is shown partially in section;

FIGS. 8E and 8F are respective simplified sectional illustrations taken along respective lines E-E and F-F in FIGS. 8B and 8C;

FIGS. 9A, 9B, 9C and 9D are simplified respective pictorial, planar top view, planar bottom view and side view illustrations of a first intermediate mounting stage in the mounting of the second bracket element onto the first bracket element in engagement with a portion of a conventional solar panel, which is shown partially in section;

FIGS. 9E, 9F and 9G are respective simplified sectional illustrations taken along respective lines E-E, F-F and G-G in FIGS. 9B and 9C;

FIGS. 10A, 10B, 10C and 10D are simplified respective pictorial, planar top view, planar bottom view and side view illustrations of a second intermediate mounting stage in the mounting of the second bracket element onto the first bracket element in engagement with a portion of a conventional solar panel, which is shown partially in section;

FIGS. 10E, 10F, 10G, 10H and 10I are respective simplified sectional illustrations taken along respective lines E-E, F-F, G-G, H-H and I-I in FIGS. 10B-10D;

FIGS. 11A, 11B, 11C and 11D are simplified respective pictorial, planar top view, planar bottom view and side view illustrations of a final mounting stage in the mounting of the second bracket element onto the first bracket element in engagement with a portion of a conventional solar panel, which is shown partially in section;

FIGS. 11E, 11F, 11G, 11H and 11I are respective simplified sectional illustrations taken along respective lines E-E, F-F, G-G, H-H and I-I in FIGS. 11B-11D;

FIGS. 12A and 12B are simplified top and bottom view pictorial illustrations of a portion of a fully assembled self-cleaning solar panel assembly constructed and operative in accordance with a preferred embodiment of the present invention; and

FIGS. 12C and 12D are simplified top and bottom view partially pictorial and partially sectional illustrations taken along a line XII-XII in FIG. 12A.

### DETAILED DESCRIPTION OF A PREFERRED EMBODIMENT

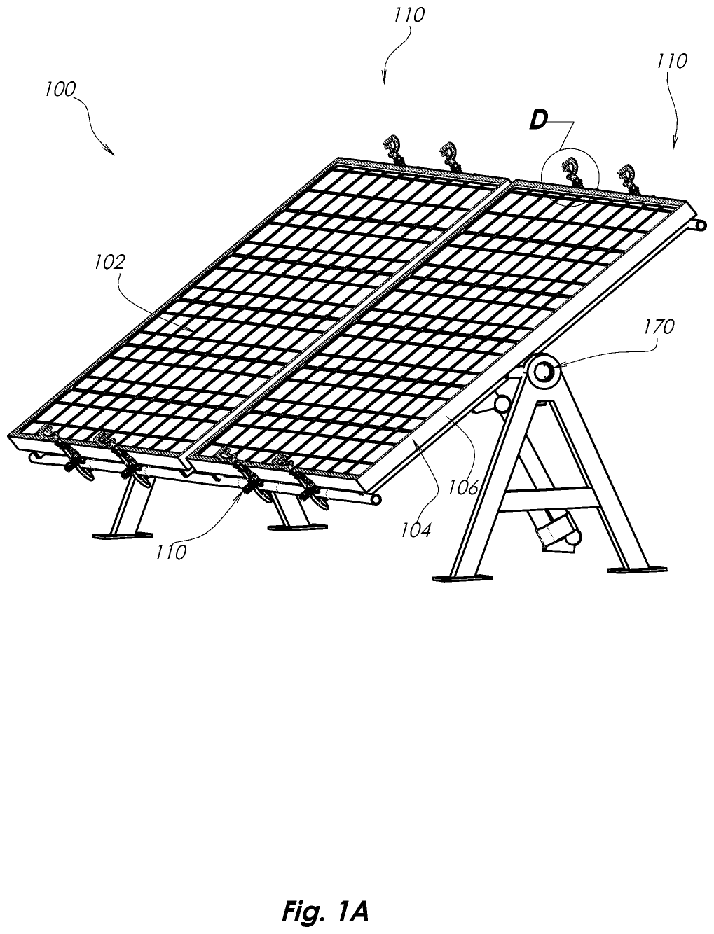

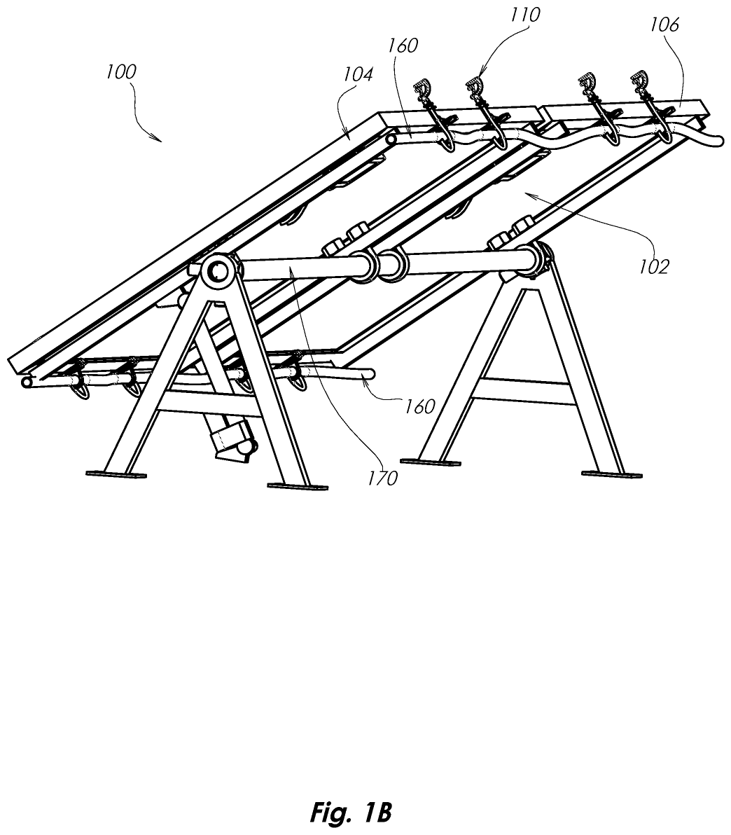

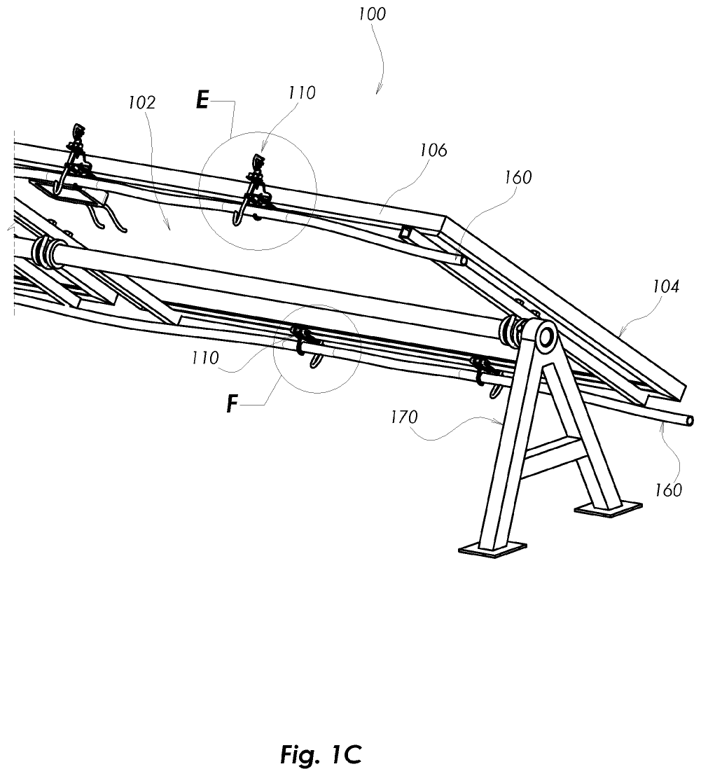

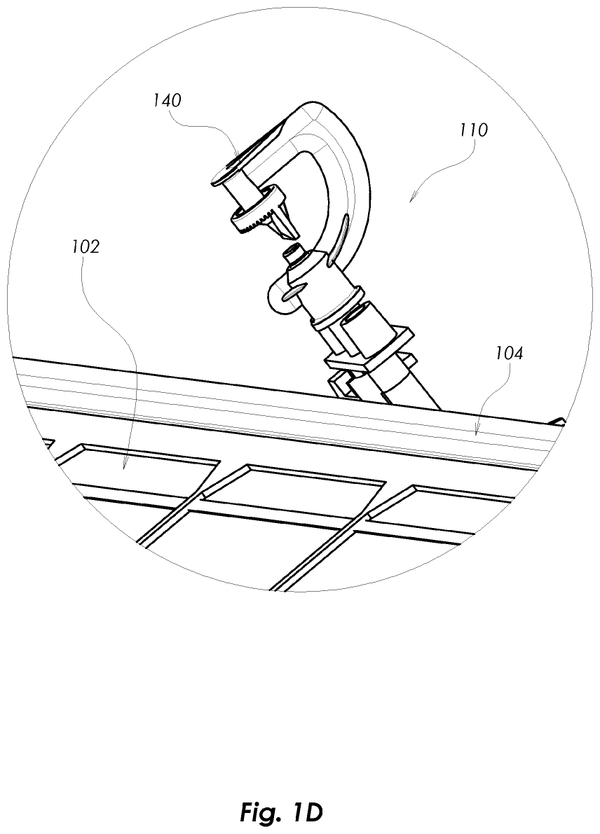

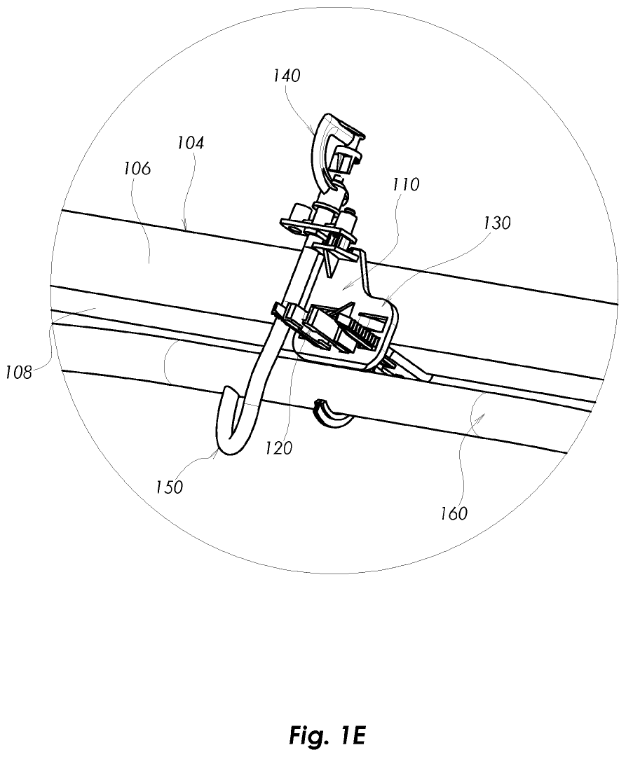

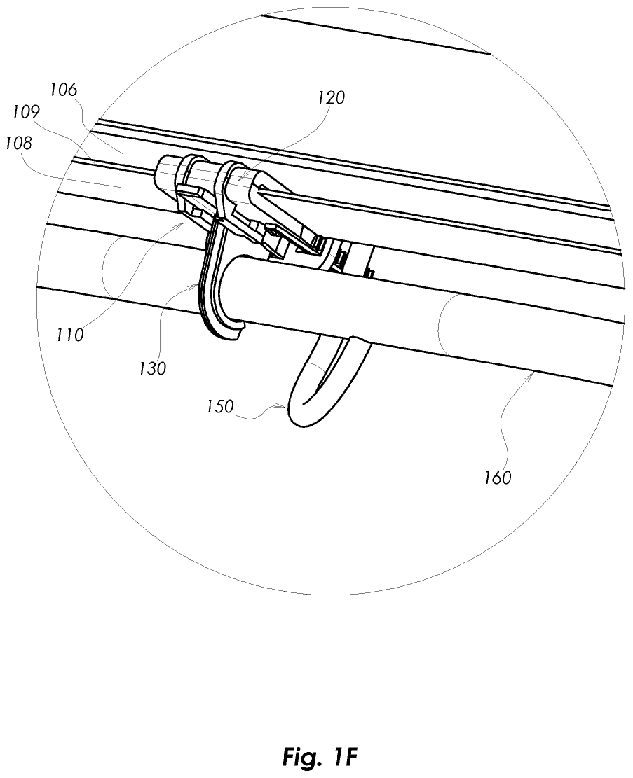

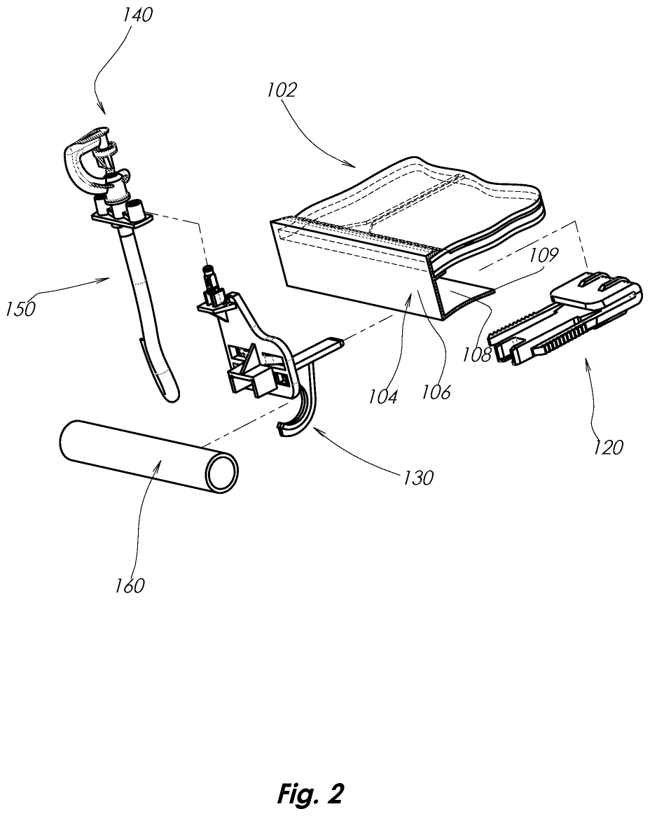

Reference is now made to FIGS. 1A-1F and FIG. 2 which illustrate a self-cleaning solar panel assembly 100 constructed and operative in accordance with a preferred embodiment of the present invention.

As seen in FIGS. 1A-1B, the self-cleaning solar panel assembly 100 preferably includes a conventional solar panel assembly 102 having a peripheral frame 104 including a peripheral wall portion 106 and a peripheral inner-facing flange 108 having an inner-facing edge 109. A plurality of preferably retrofittable sprayer mount assemblies 110 are removably attached to the peripheral frame 104.

Each of the plurality of sprayer mount assemblies 110 preferably includes a first bracket element 120 and a second bracket element 130 which are preferably removably joined together for clamping onto the peripheral frame 104. At least one sprayer 140 is mounted onto each sprayer mount assembly 110 and receives a cleaning liquid, such as water via a supply hose 150 from a cleaning liquid manifold 160, which in turn is preferably mounted onto plural sprayer mount assemblies and coupled to a source of pressurized liquid, such as a water source (not shown).

Typically, each solar panel assembly 102 is pivotably mounted onto a pivotable mounting assembly 170, but this need not necessarily be the case. Typically multiple solar panel assemblies 102 are mounted on a single pivotable mounting assembly as shown.

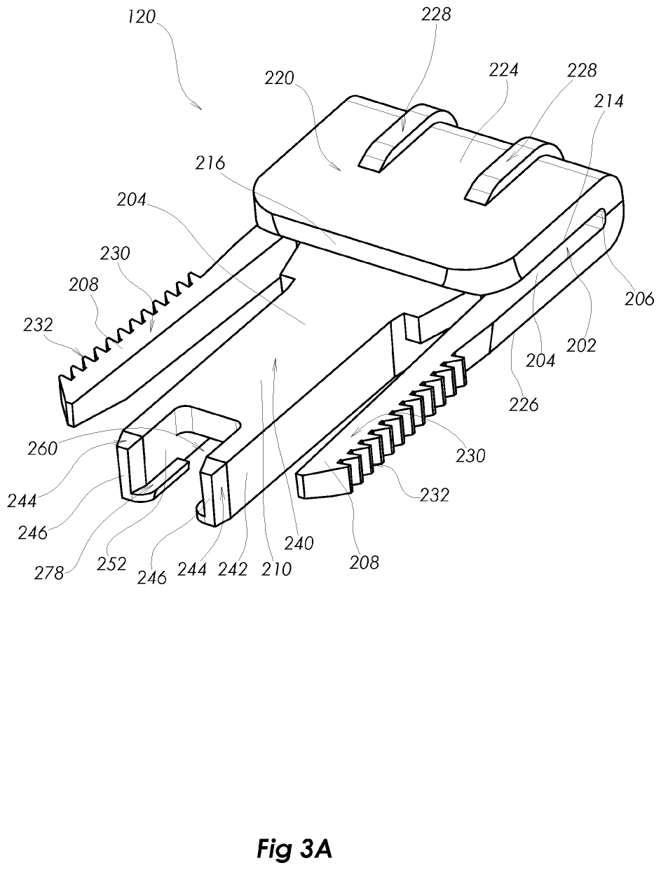

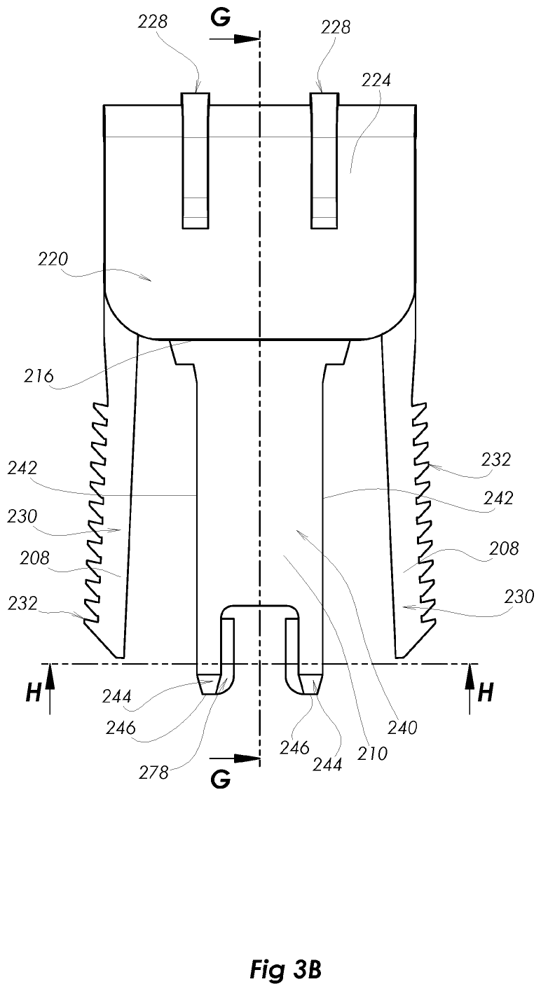

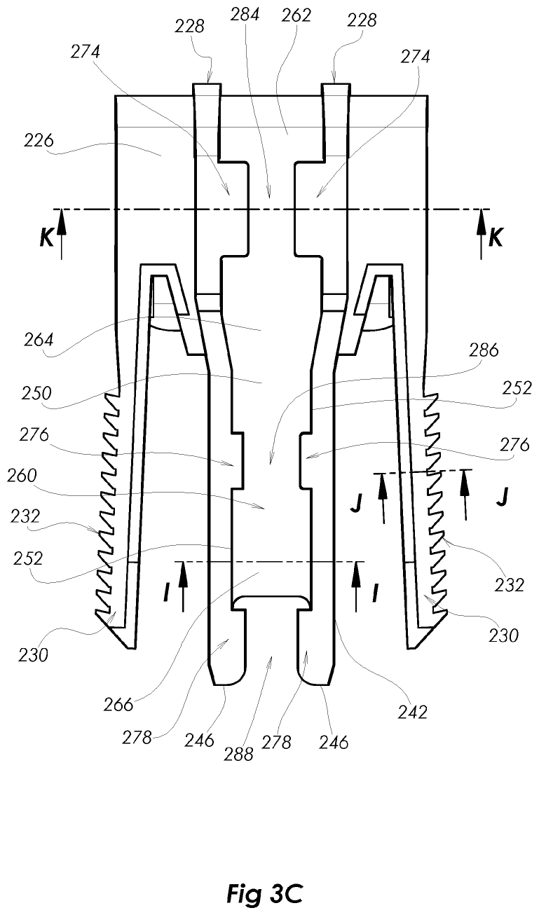

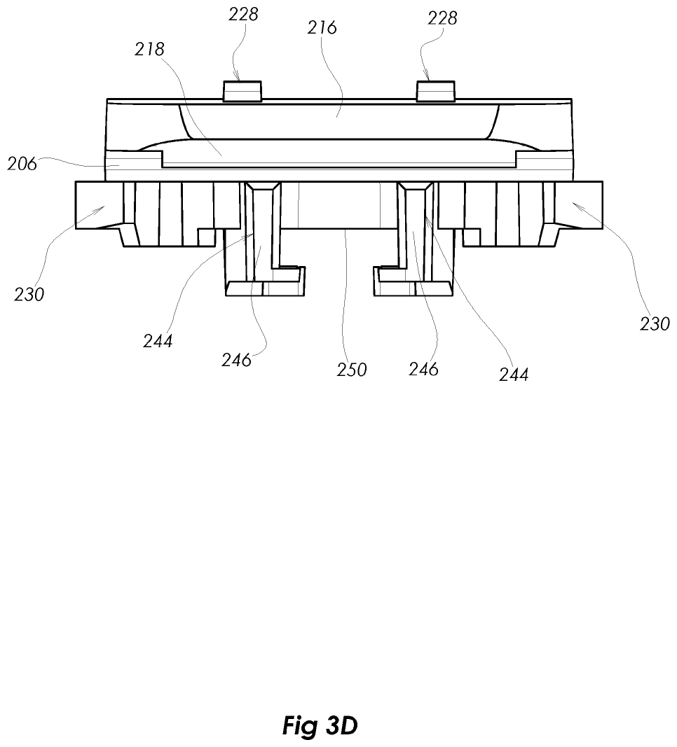

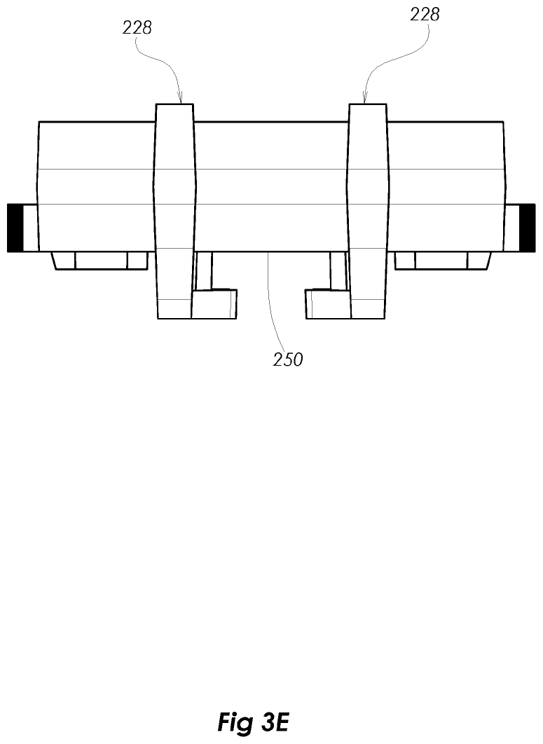

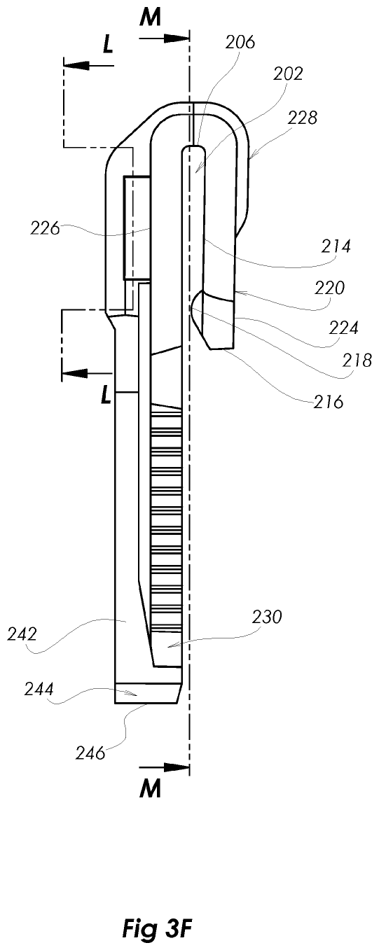

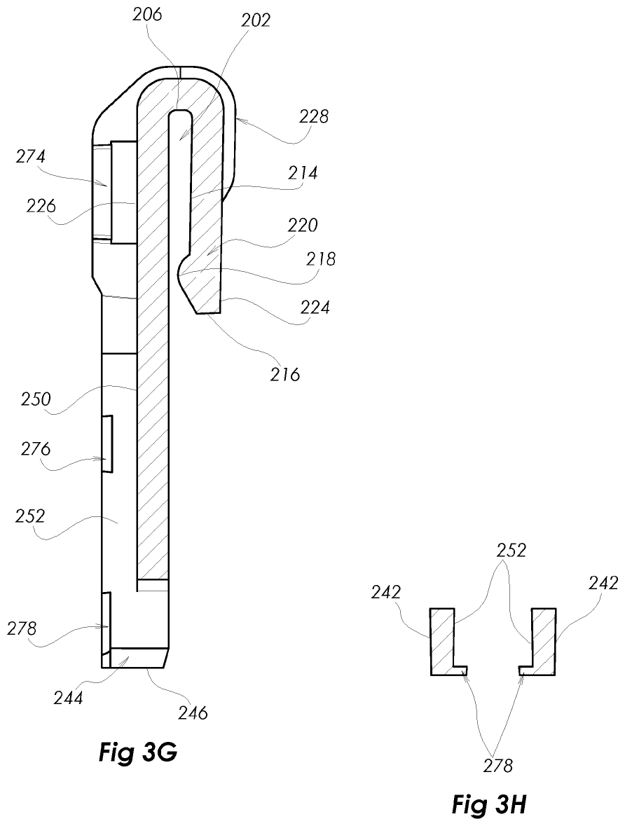

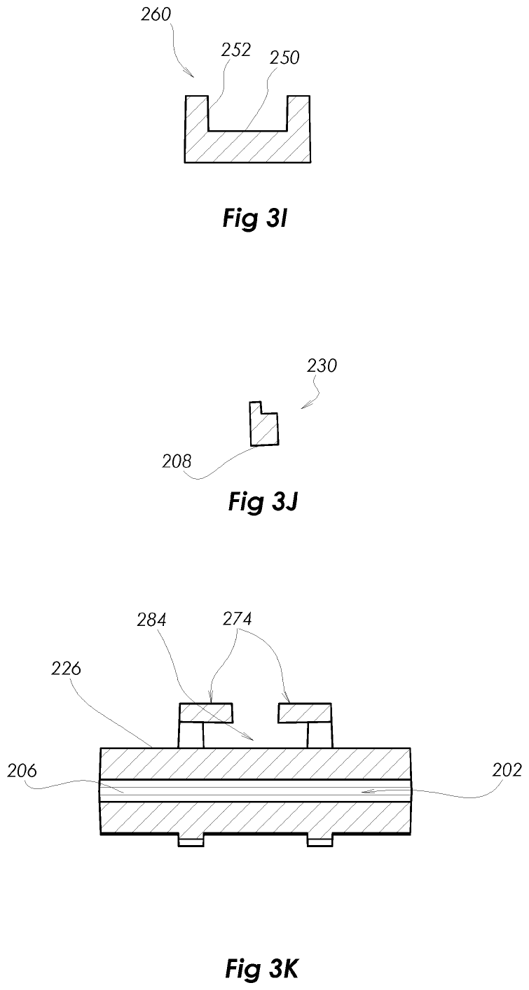

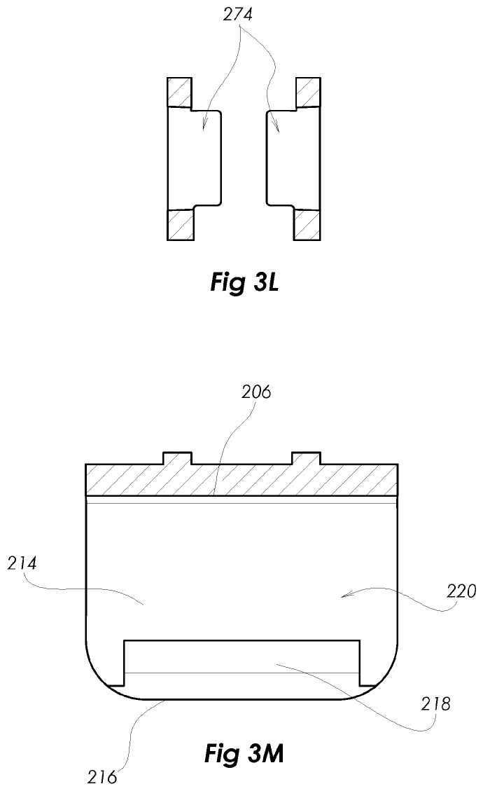

Reference is now made to FIGS. 3A-3M, which illustrate a preferred embodiment of first bracket element 120. As seen in FIGS. 3A-3M, the first bracket element 120 preferably is a partially folded-over element which defines a slot 202 for removably but snugly receiving inner-facing flange 108 of peripheral frame 104 of conventional solar panel assembly 102.

An upwardly-facing wall surface 204 of slot 202 is generally planar and extends from an end wall 206 of slot 202, which preferably engages inner-facing edge 109 of inner-facing flange 108 of peripheral frame 104 of conventional solar panel assembly 102. Generally planar upwardly-facing wall surface 204 extends in a direction away from end wall 206 and defines a pair of flexible ratcheted arm surfaces 208 which are mutually spaced from each other and from an upwardly-facing center support and guiding finger surface 210.

A downwardly-facing wall surface 214 of slot 202 is generally planar and extends from end wall 206 of slot 202 to an edge 216. An elongate downward-facing protrusion 218 extends from downwardly-facing wall surface 214 generally parallel to end wall 206 for resiliently and snugly removably engaging a top surface of inner-facing flange 108 of peripheral frame 104 of conventional solar panel assembly 102.

Downwardly-facing wall surface 214 is defined on a folded-over portion 220 of first bracket element 120, which also defines an upwardly-facing wall surface 224, which extends from edge 216 and is bent over end wall 206 to extend into a bottom-facing wall surface 226 which underlies upwardly-facing wall surface 204. A pair of mutually spaced reinforcement protrusions 228 extend outwardly from part of upwardly-facing wall surface 224 and are bent over end wall 206 and underlie part of bottom-facing wall surface 226.

Preferably each of flexible ratcheted arm surfaces 208 defines a surface of a corresponding ratcheted arm 230, which defines a generally elongate array of outwardly-extending ratchet teeth 232. Ratcheted arms 230 are preferably manually squeezable towards each other in the plane of flexible ratcheted arm surfaces 208 for enabling manual disengagement of the first and second brackets from each other and from inner-facing flange 108 of peripheral frame 104 of conventional solar panel assembly 102.

Upwardly-facing center support and guiding finger surface 210 defines an upwardly-facing surface of a central support and guiding finger 240, which extends away from end wall 206, generally parallel to and spaced from ratcheted arms 230. Central support and guiding finger 240 also preferably defines a pair of mutually oppositely facing generally parallel side surfaces 242, each having a tapered extreme end portion 244 terminating in an edge 246.

Central support and guiding finger 240 is also formed with a downwardly-facing center support and guiding finger surface 250, which underlies upwardly-facing center support and guiding finger surface 210 and extends generally parallel thereto, and defines a continuation of bottom-facing wall surface 226.

Downwardly-facing center support and guiding finger surface 250 is preferably bounded by a pair of inner-facing surfaces 252, which define, together with downwardly-facing center support and guiding finger surface 250, a receiving and guiding slot 260. Slot 260 preferably defines a relatively wide slot portion 262 closest to end wall 206, which extends into an inwardly tapered slot portion 264, which extends into a relatively narrow slot portion 266 which terminates at edges 246.

Inner-facing surfaces 252 define three pairs of mutually inwardly-facing protrusions, respectively designated 274, 276 and 278, spaced from downwardly-facing center support and guiding finger surface 250 and each defining together with inner-facing surfaces 252 and downwardly-facing center support and guiding finger surface 250 a partial circumferential frictional engagement location therewith, respectively designated by reference numerals 284, 286 and 288.

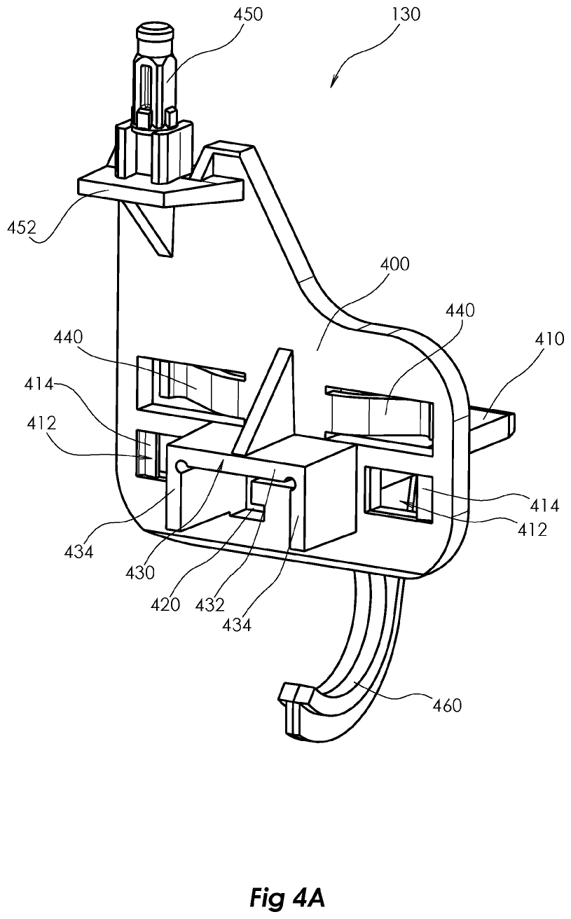

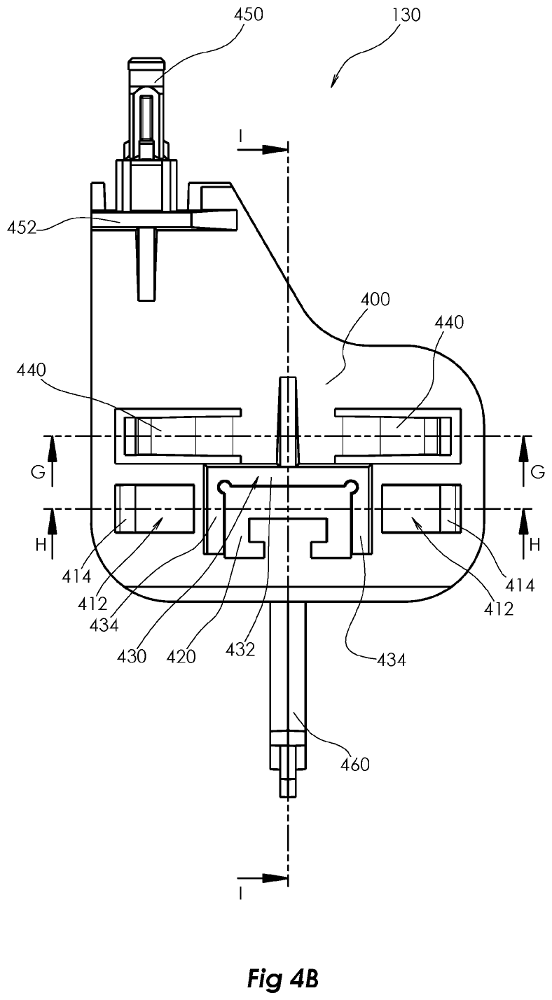

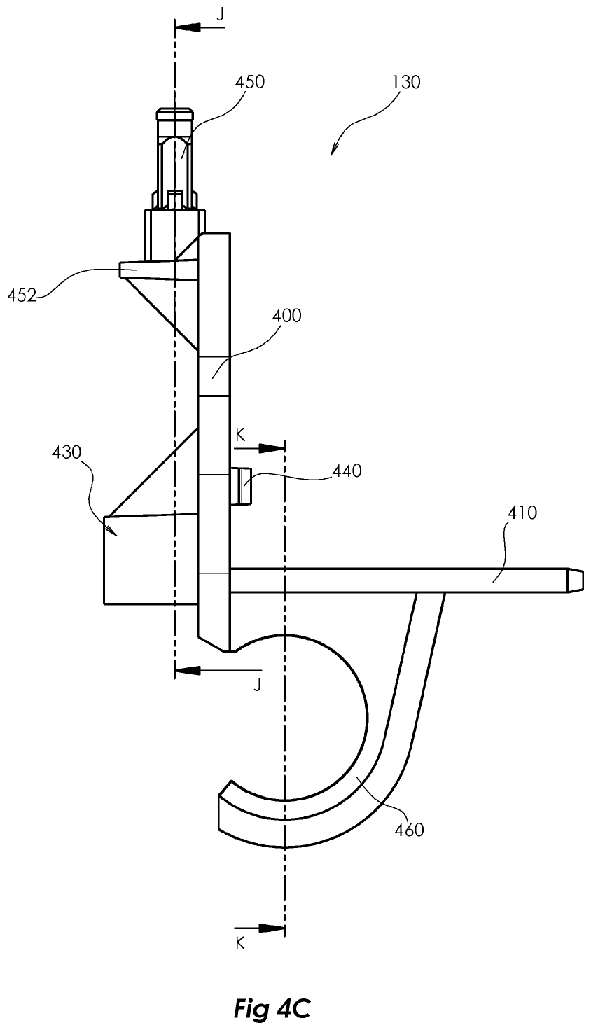

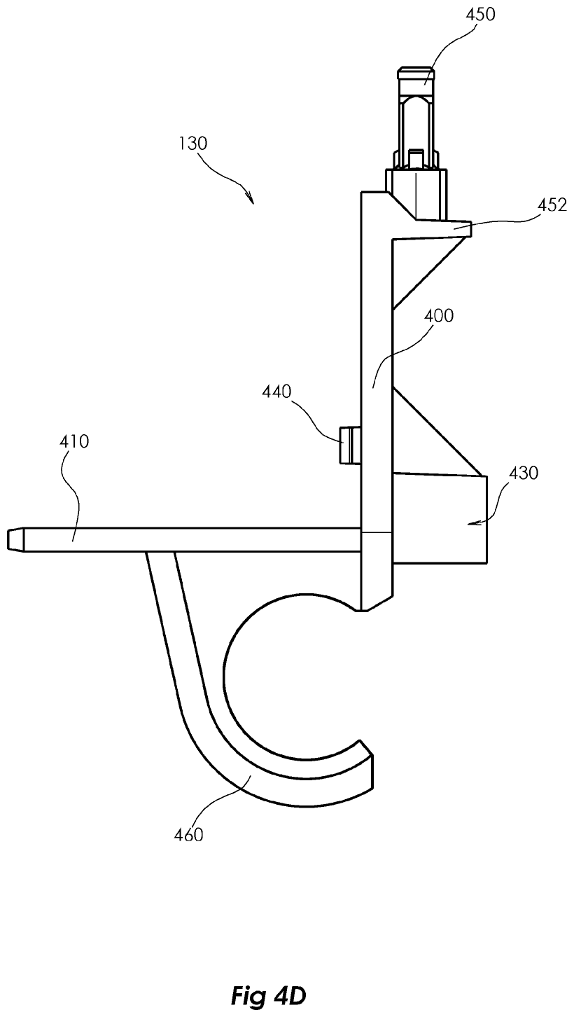

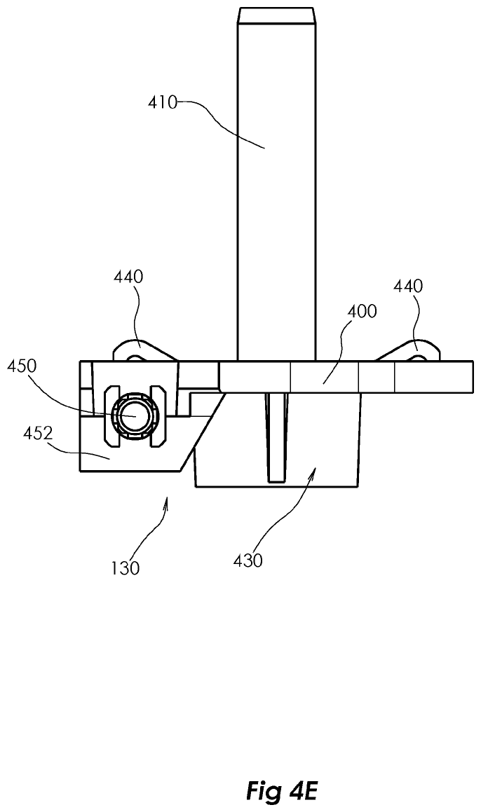

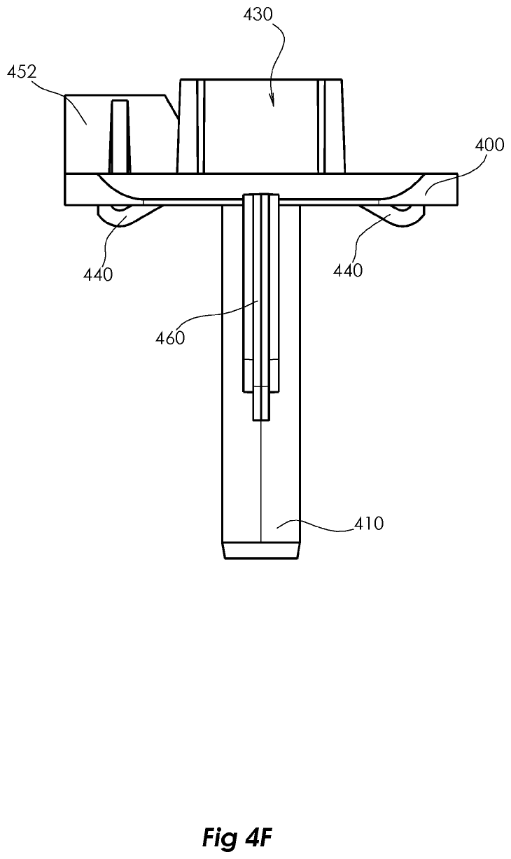

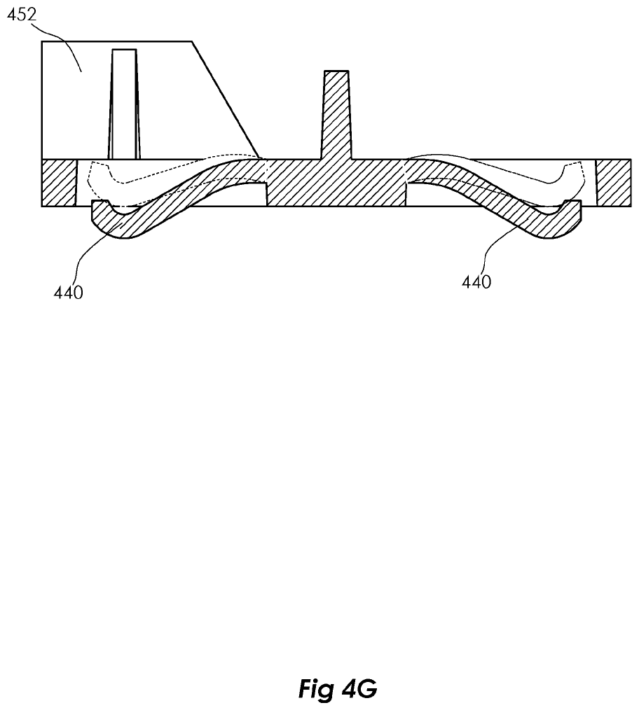

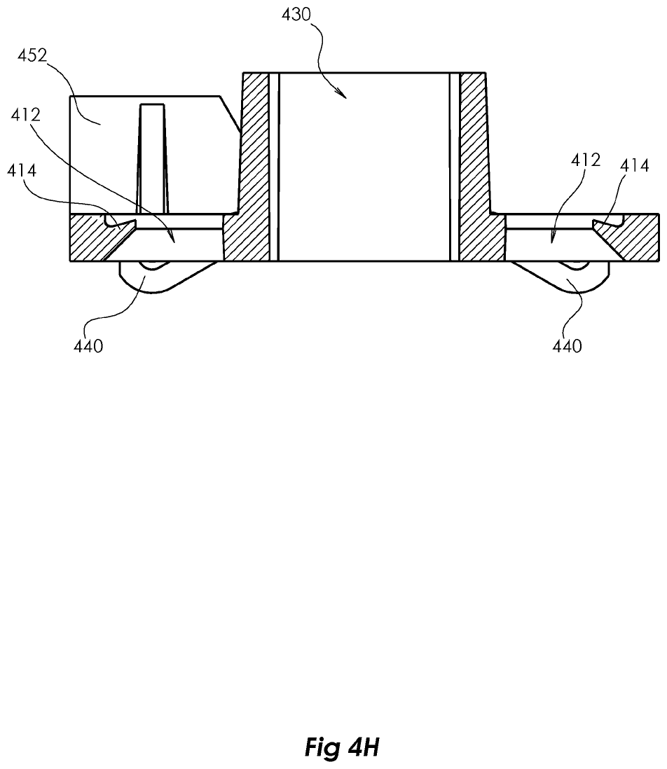

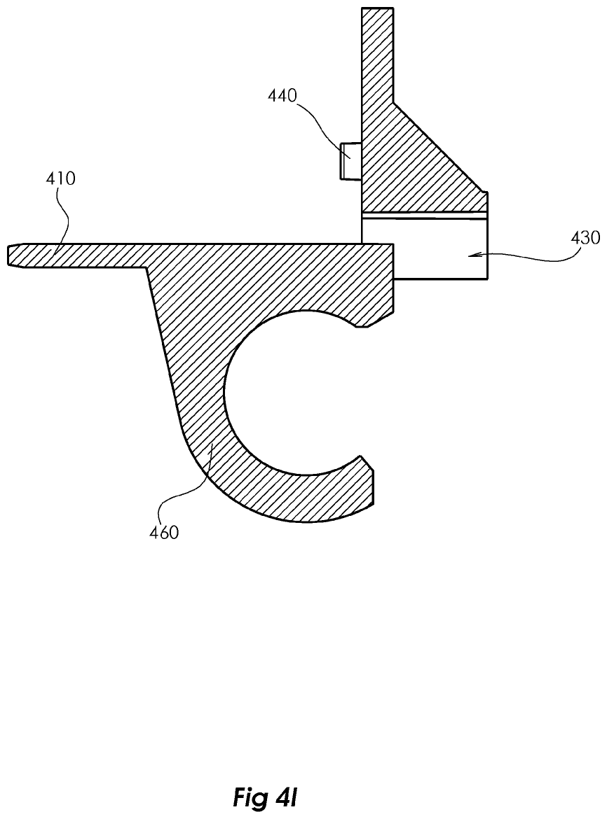

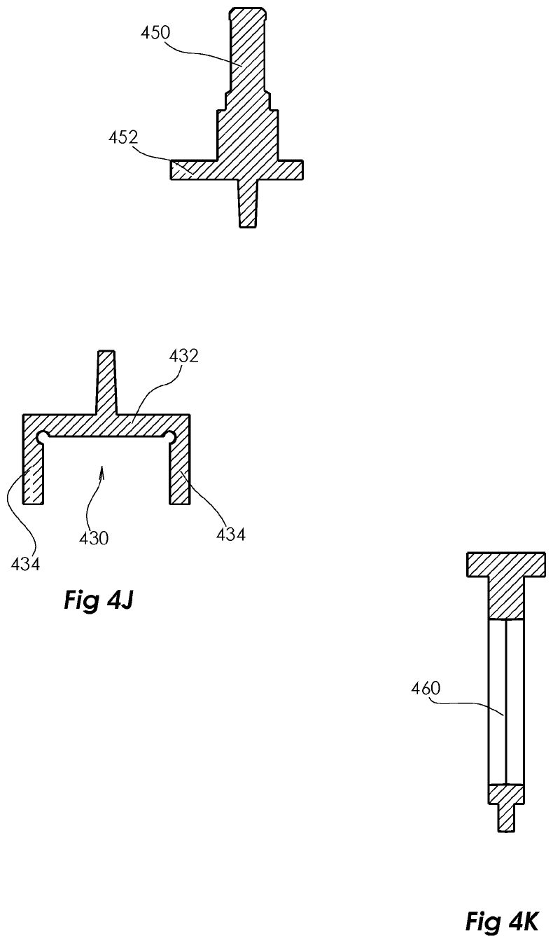

Reference is now made to FIGS. 4A, 4B, 4C, 4D, 4E and 4F, which are simplified respective pictorial, front planar, first side planar, second side planar, top planar and bottom planar illustrations of second bracket element 130 forming part of the sprayer mount assembly of FIG. 2, and to FIGS. 4G, 4H, 4I, 4J and 4K, which are respective simplified sectional illustrations taken along respective lines G-G, H-H, I-I, J-J and K-K in FIGS. 4B and 4C.

As seen in FIGS. 4A-4K, the second bracket element 130 comprises a main generally planar portion 400 and a secondary generally planar portion 410 extending generally perpendicularly thereto. Main generally planar portion 400 preferably comprises a pair of mutually spaced apertures 412, each of which is formed with a preferably relatively thin tooth engagement wall portion 414, for engagement with ratchet teeth 232 of first bracket element 120. Intermediate apertures 412 is a main aperture 420 which is configured to slidably receive central support and guiding finger 240 of first bracket element 120.

Secondary planar portion 410 extends generally perpendicularly to main generally planar portion 400 from a central location partially surrounded by main aperture 420 in a first direction. A channel-defining protrusion 430 extends generally perpendicularly to main generally planar portion 400 from locations partially surrounding main aperture 420 in a second direction, opposite to the first direction. The channel-defining protrusion 430 includes a top wall portion 432 and a pair of side wall portions 434.

Main generally planar portion 400 is preferably formed with a pair of resilient fingers 440 which extend slightly in the first direction and are intended to provide a press fit with a peripheral wall portion 106 of frame 104 when mounted thereon.

Main generally planar portion 400 is preferably formed with an upstanding sprayer mounting pin 450, which extends generally upwardly from a sprayer mounting platform 452, which platform extends generally perpendicularly to main generally planar portion 400 in the second direction.

Extending generally downwardly from secondary planar portion 410 is a water supply tube mounting hook portion 460, which is sized to slidably retain cleaning liquid manifold 160 in engagement with frame 104.

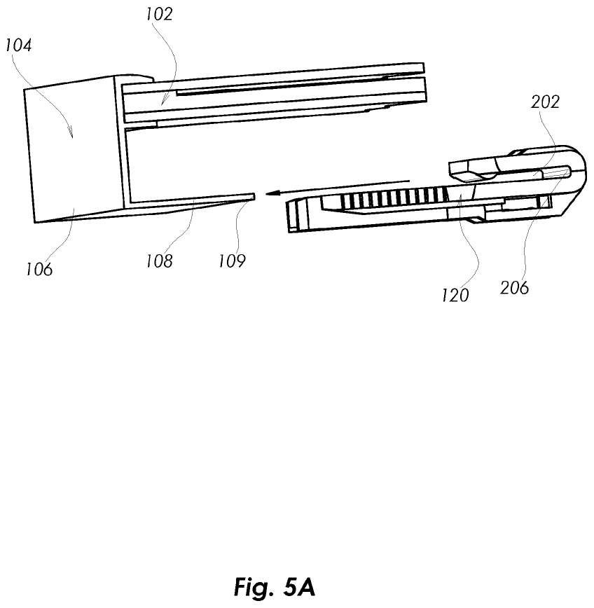

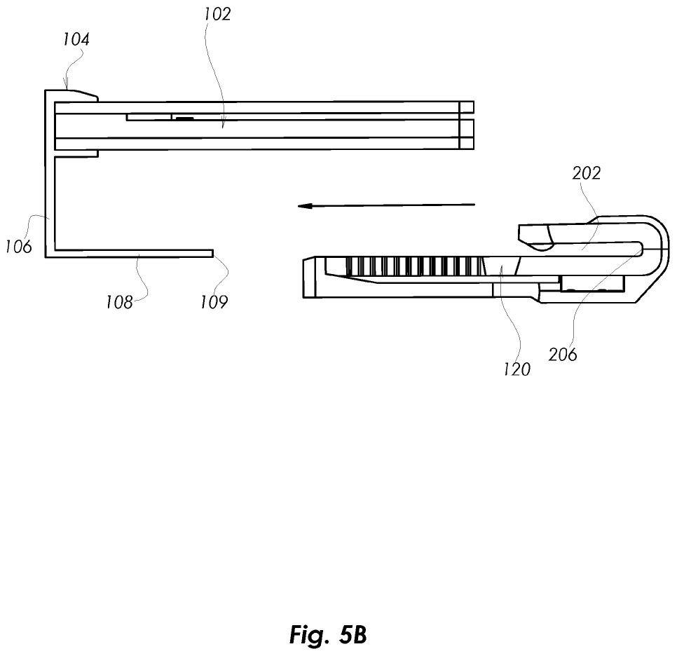

Reference is now made to FIGS. 5A and 5B, which are simplified respective pictorial and side view illustrations of a pre-mounting stage in the mounting of the first bracket element 120 onto a portion of a conventional solar panel, which is shown partially in section. It is seen that slot 202 of the first bracket element 120 is generally aligned with inner-facing flange 108 of peripheral frame 104 of conventional solar panel assembly 102.

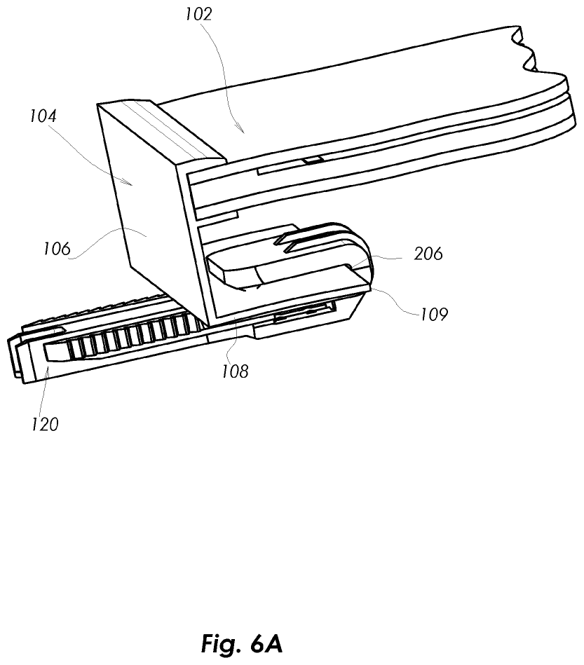

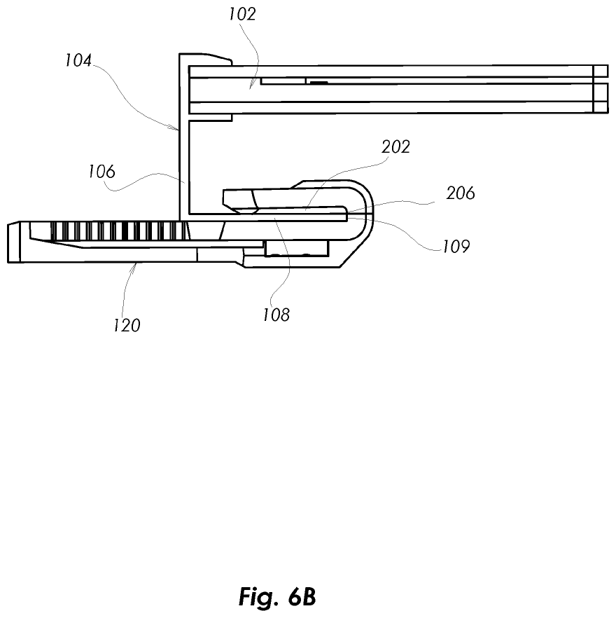

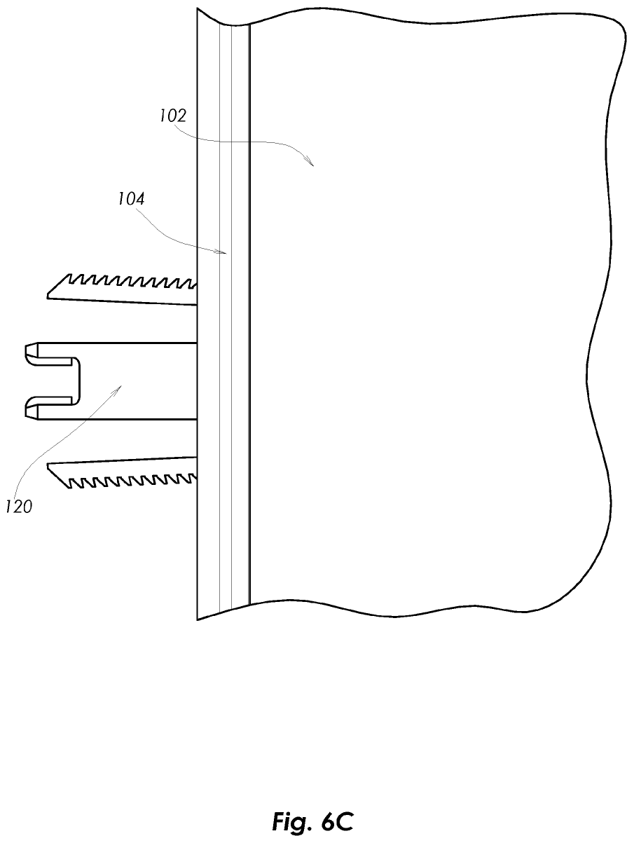

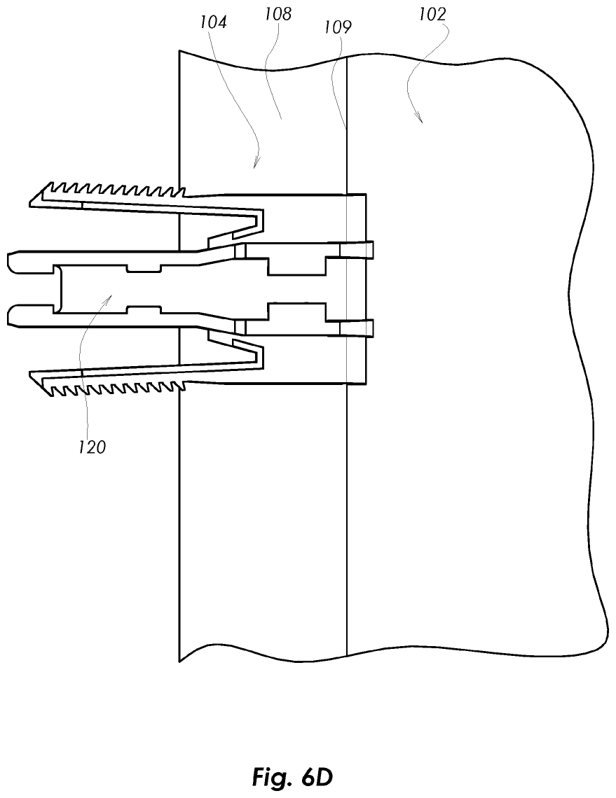

Reference is now made to FIGS. 6A-6D, which illustrate a fully mounted stage in the mounting of the first bracket element 120 onto inner-facing flange 108 of peripheral frame 104 of conventional solar panel assembly 102, such that inner-facing edge 109 of peripheral inner-facing flange 108 lies in touching engagement with end wall 206 of slot 202 of first bracket element 120.

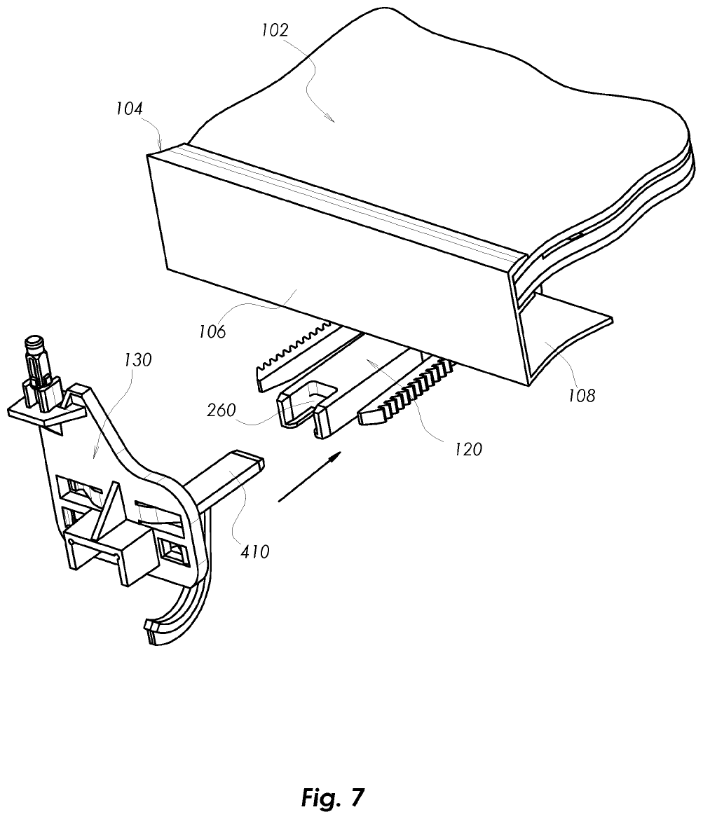

Reference is now made to FIG. 7, which is a simplified pictorial illustration of a pre-mounting stage in the mounting of second bracket element 130 onto first bracket element 120 in engagement with inner-facing flange 108 of peripheral frame 104 of conventional solar panel assembly 102. It is seen that the secondary planar portion 410 of the second bracket element 130 is generally aligned with receiving and guiding slot 260 of first bracket element 120.

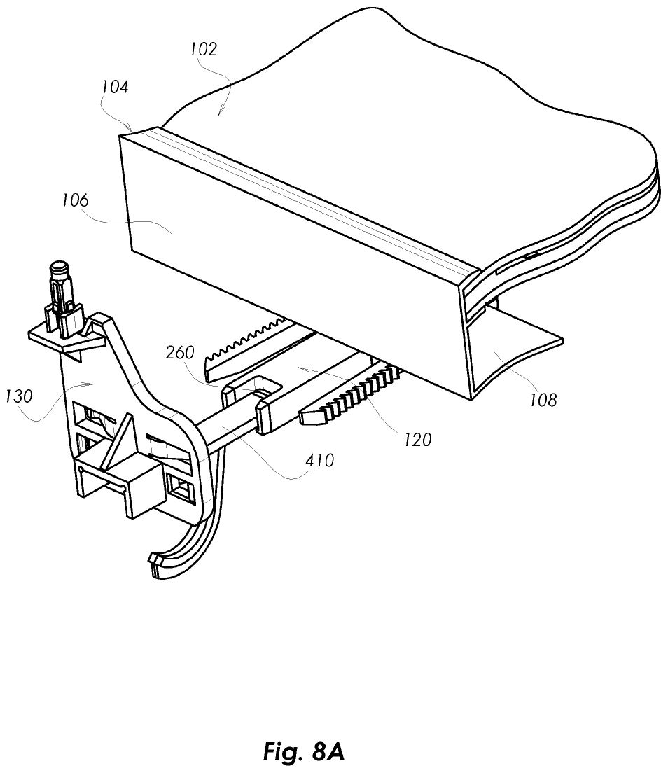

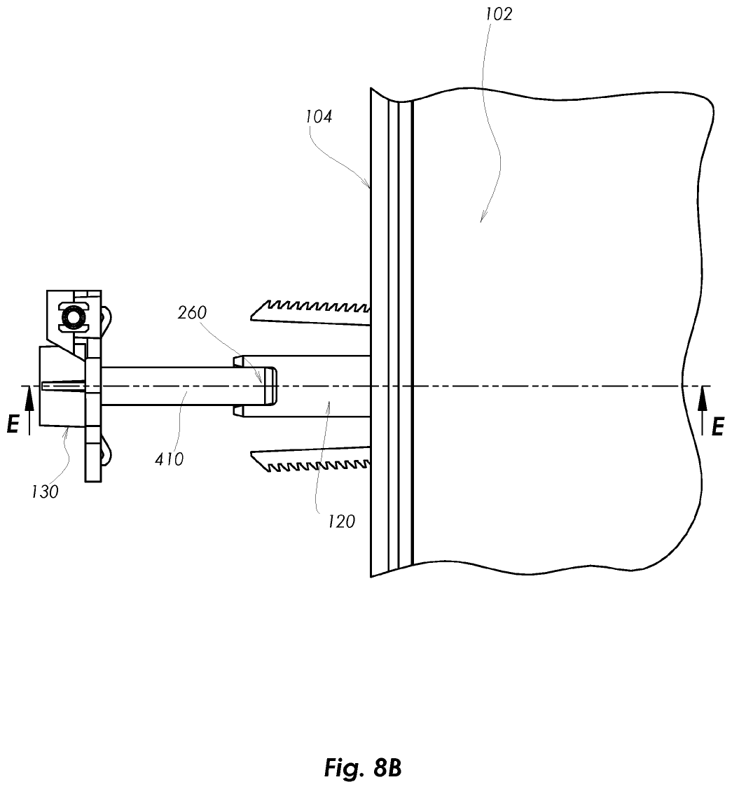

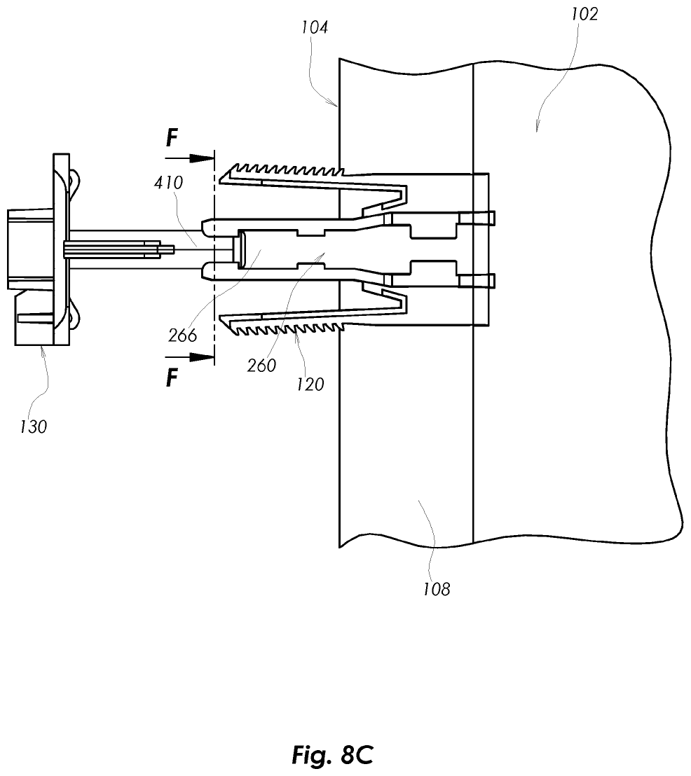

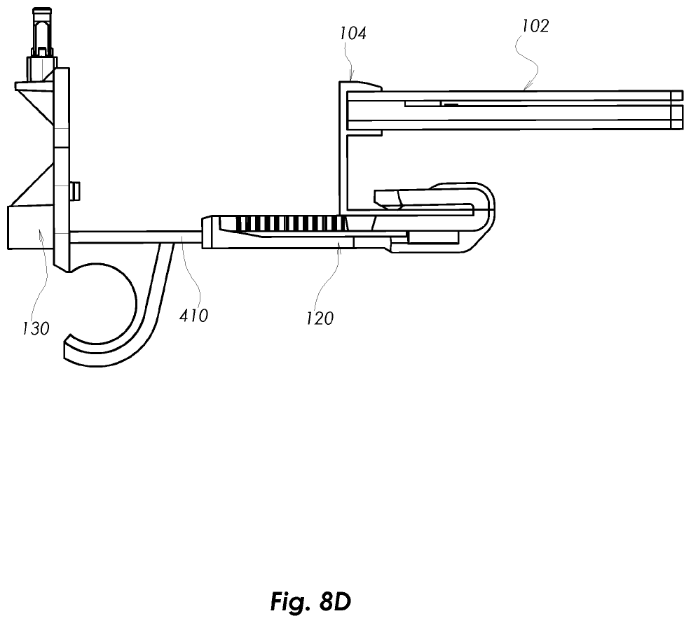

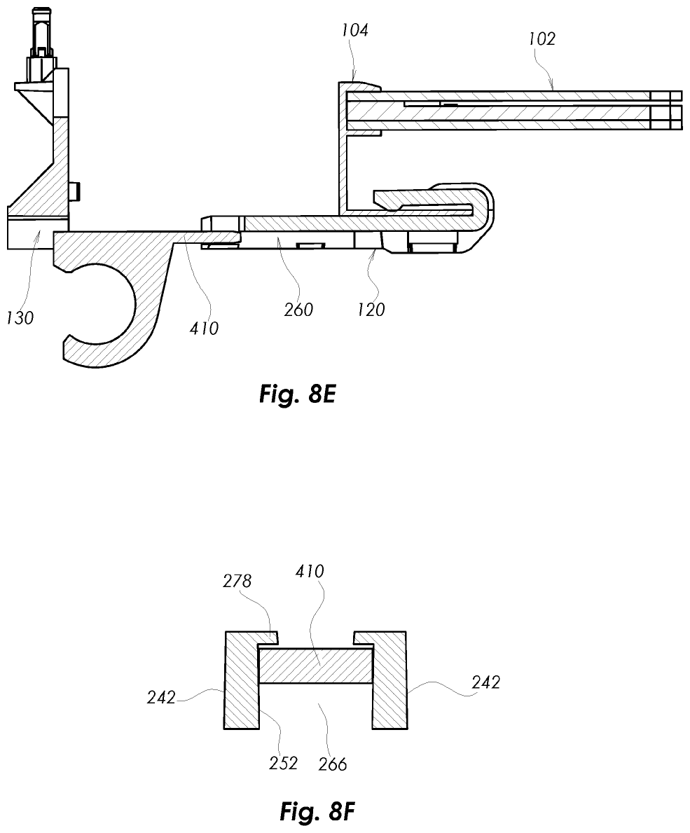

Reference is now made to FIGS. 8A-8F, which are simplified illustrations of an initial mounting stage in the mounting of second bracket element 130 onto the first bracket element 120 in engagement with inner-facing flange 108 of peripheral frame 104 of conventional solar panel assembly 102. It is seen that the secondary planar portion 410 of the second bracket element 130 is engaged with relatively narrow slot portion 266 of receiving and guiding slot 260 of first bracket element 120.

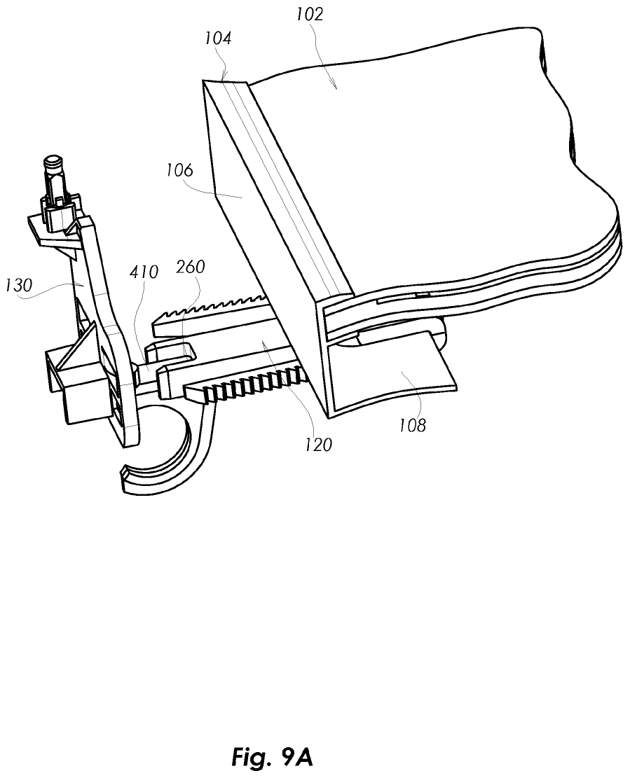

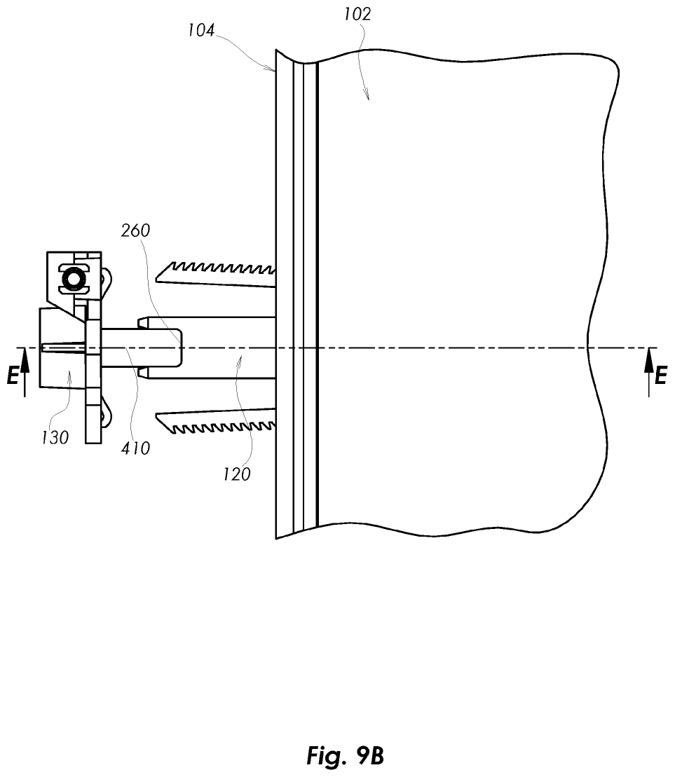

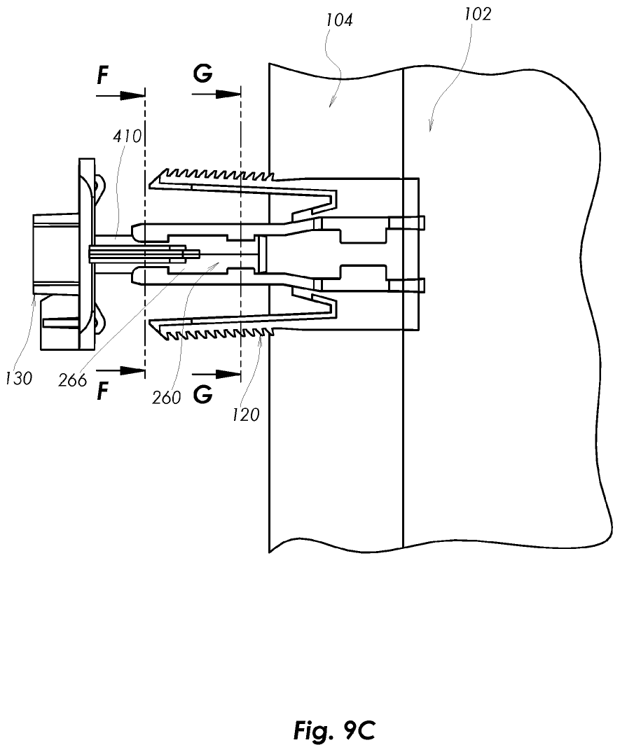

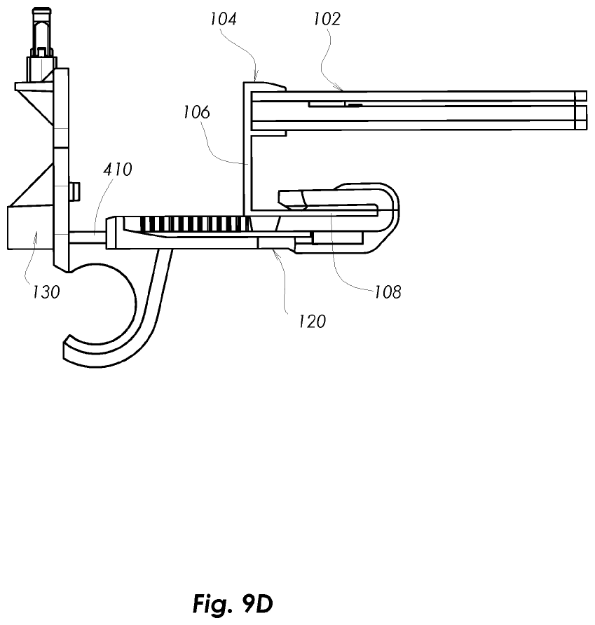

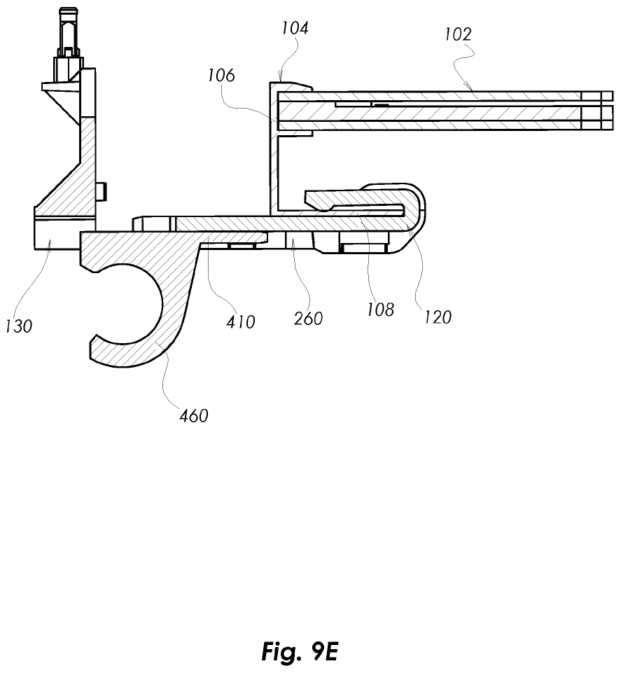

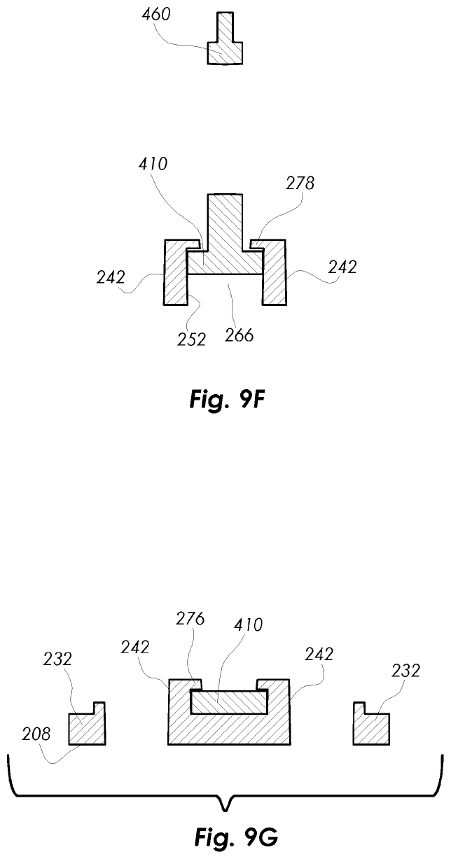

Reference is now made to FIGS. 9A-9G, which are simplified illustrations of a first intermediate mounting stage in the mounting of second bracket element 130 onto the first bracket element 120 in engagement with inner-facing flange 108 of peripheral frame 104 of conventional solar panel assembly 102. It is seen that the secondary planar portion 410 of the second bracket element 130 is more deeply engaged with relatively narrow slot portion 266 of receiving and guiding slot 260 of first bracket element 120.

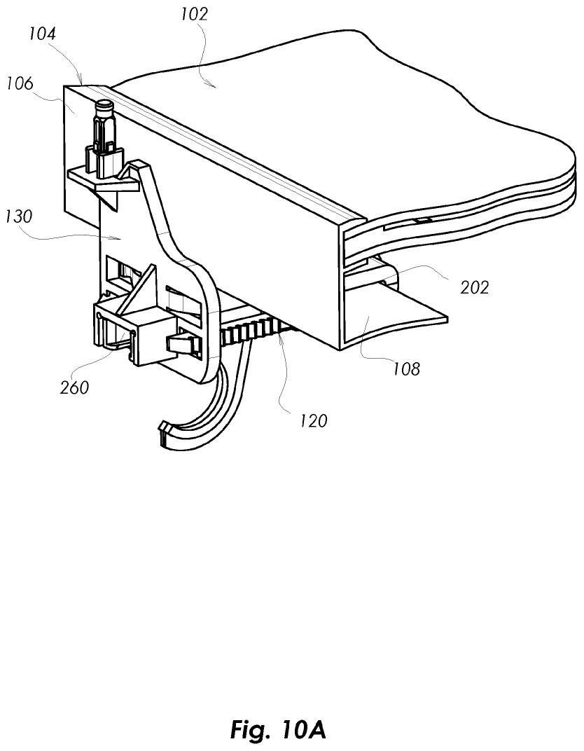

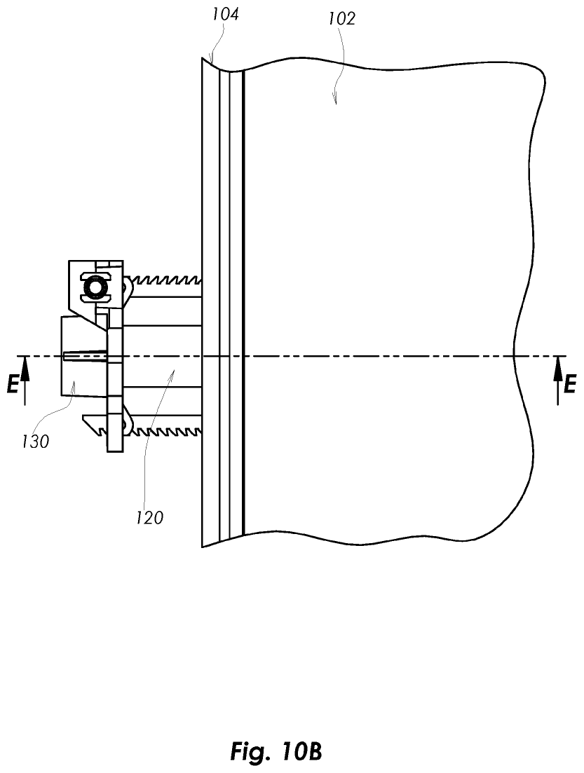

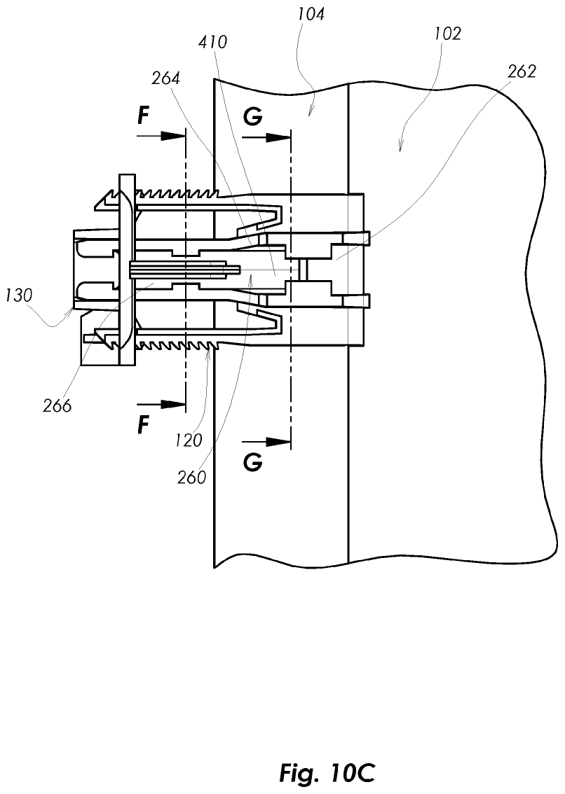

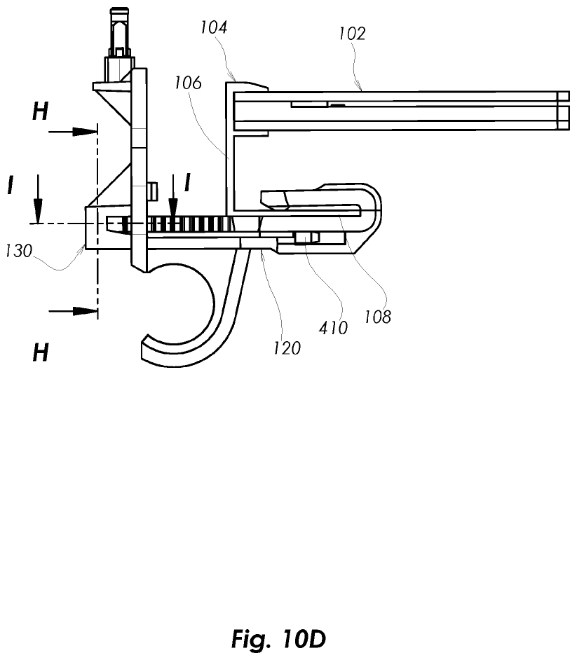

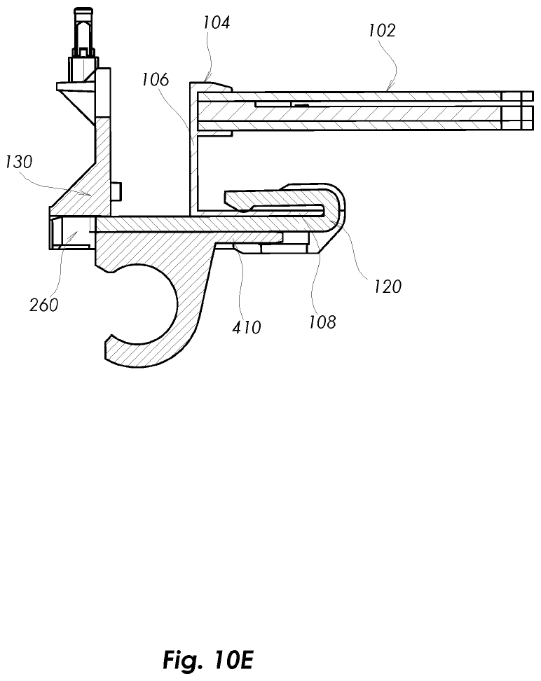

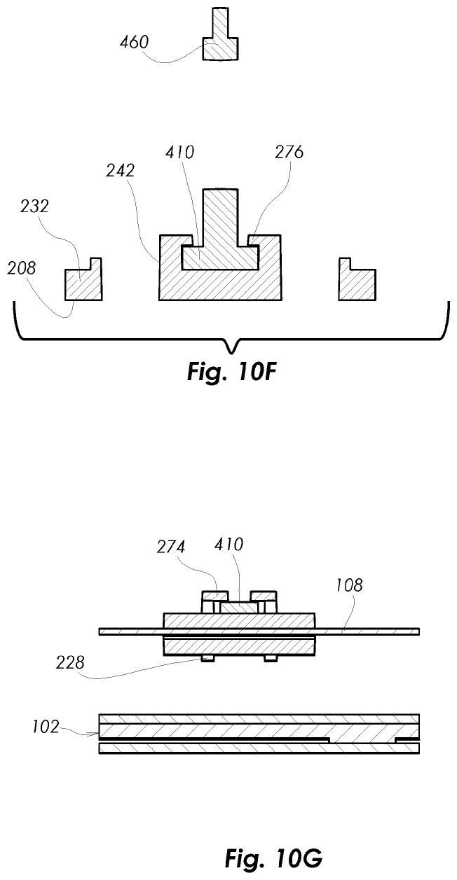

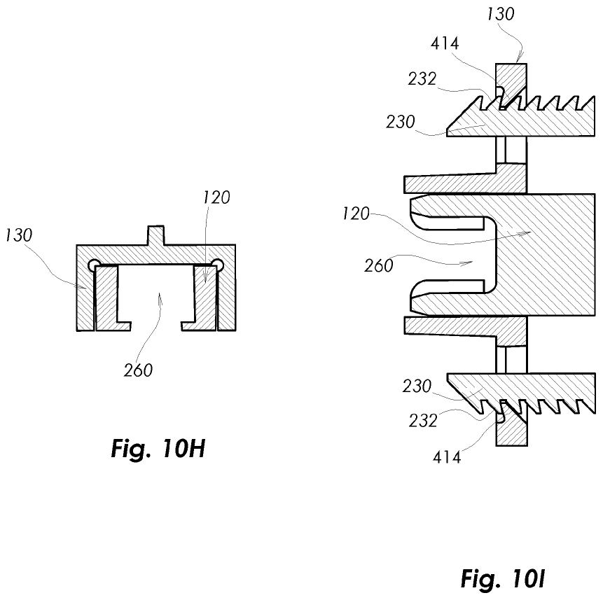

Reference is now made to FIGS. 10A-10I, which are simplified illustrations of a second intermediate mounting stage in the mounting of second bracket element 130 onto the first bracket element 120 in engagement with inner-facing flange 108 of peripheral frame 104 of conventional solar panel assembly 102. It is seen that the secondary planar portion 410 of the second bracket element 130 is engaged with relatively narrow slot portion 266, inwardly tapered slot portion 264 and relatively wide slot portion 262 of receiving and guiding slot 260 of first bracket element 120.

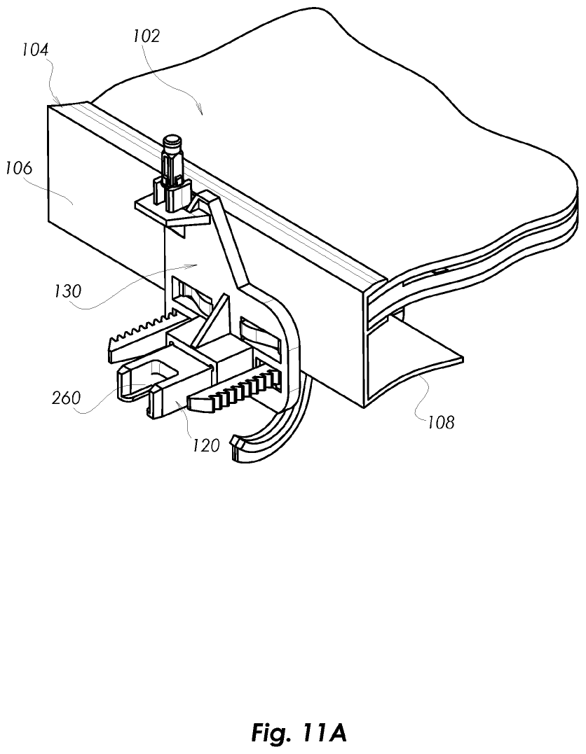

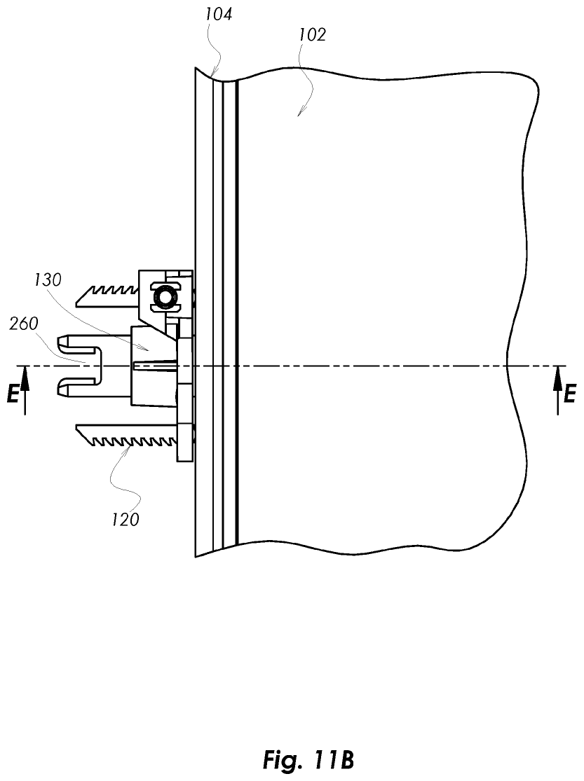

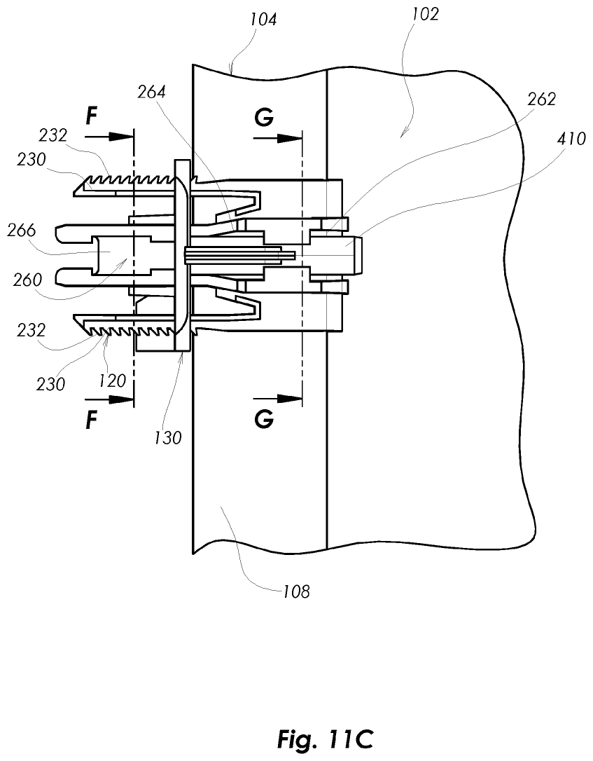

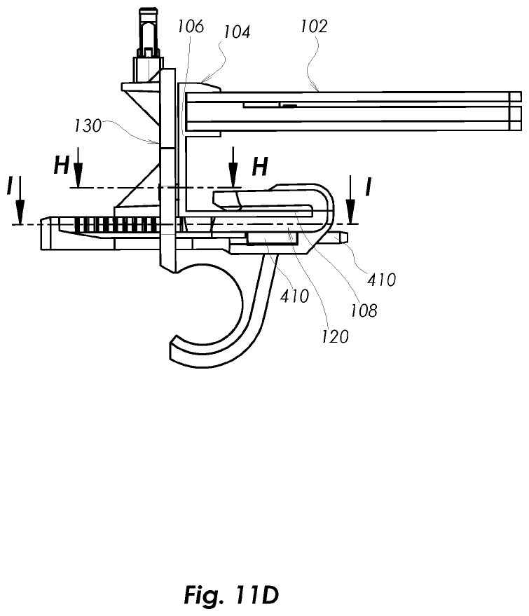

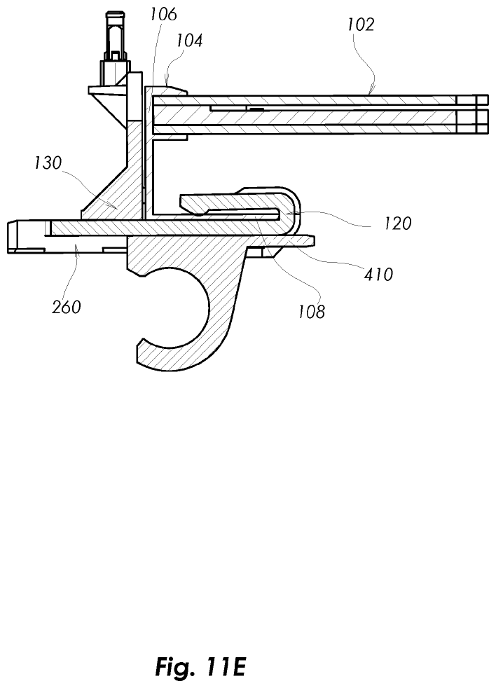

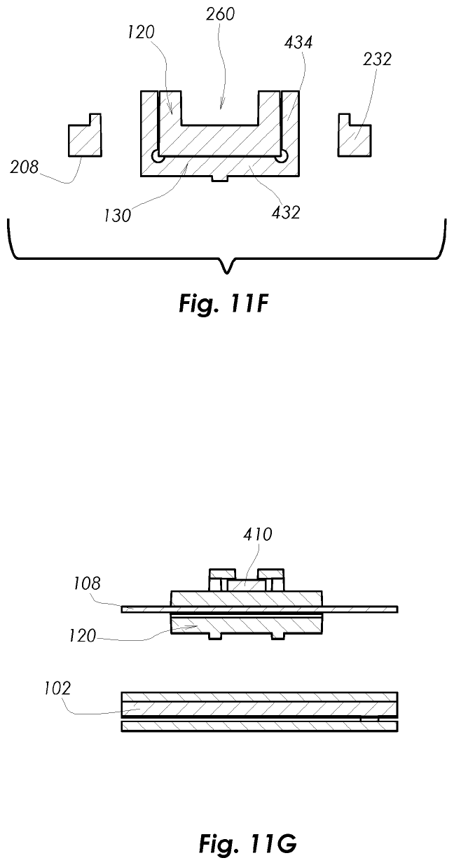

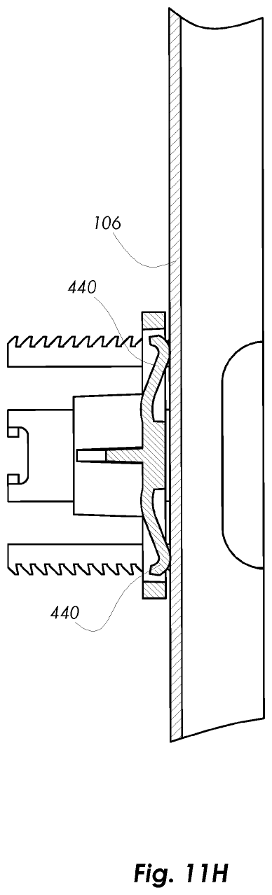

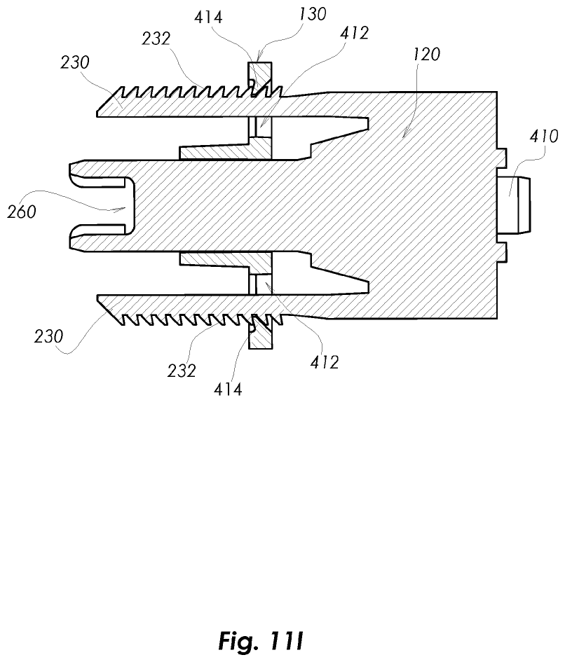

Reference is now made to FIGS. 11A-11I, which are simplified illustrations of a final mounting stage in the mounting of second bracket element 130 onto the first bracket element 120 in engagement with inner-facing flange 108 of peripheral frame 104 of conventional solar panel assembly 102. It is seen that the secondary planar portion 410 of the second bracket element 130 extends entirely through and beyond receiving and guiding slot 260 of first bracket element 120 and that first bracket element 120 and second bracket element 130 are retained in tight, snug engagement with peripheral frame 104 of conventional solar panel assembly 102 by engagement of ratchet teeth 232 of first bracket element 120 with wall portions 414 of second bracket element 130.

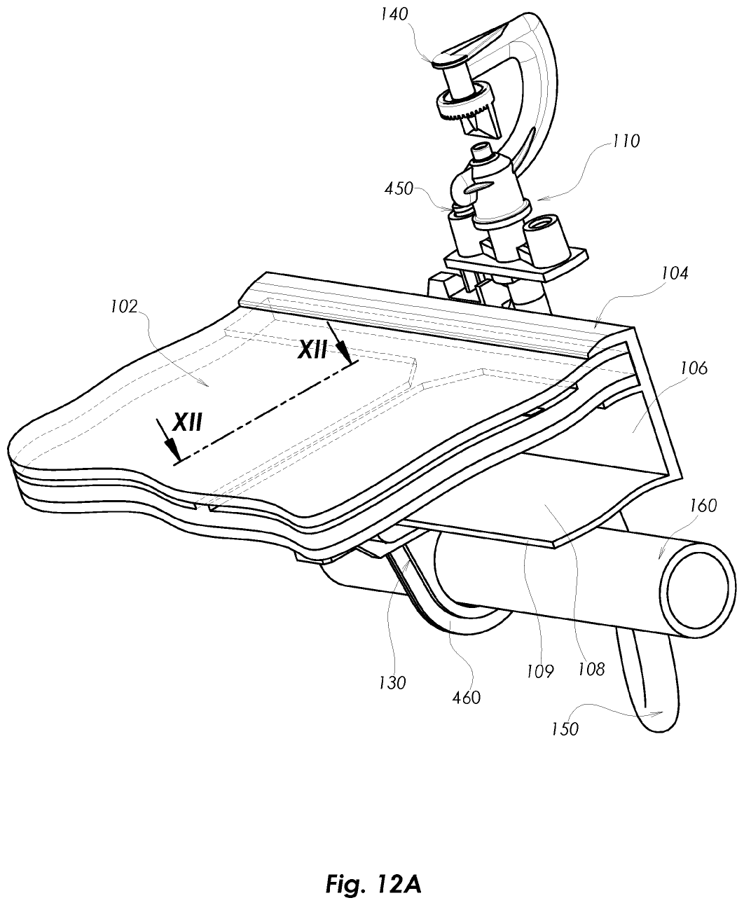

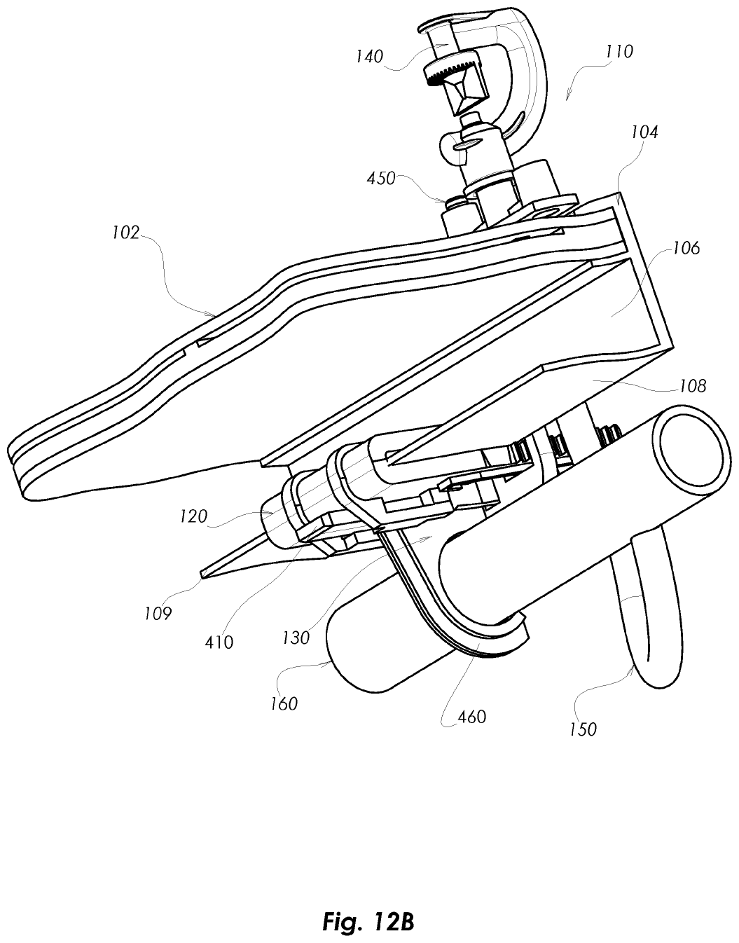

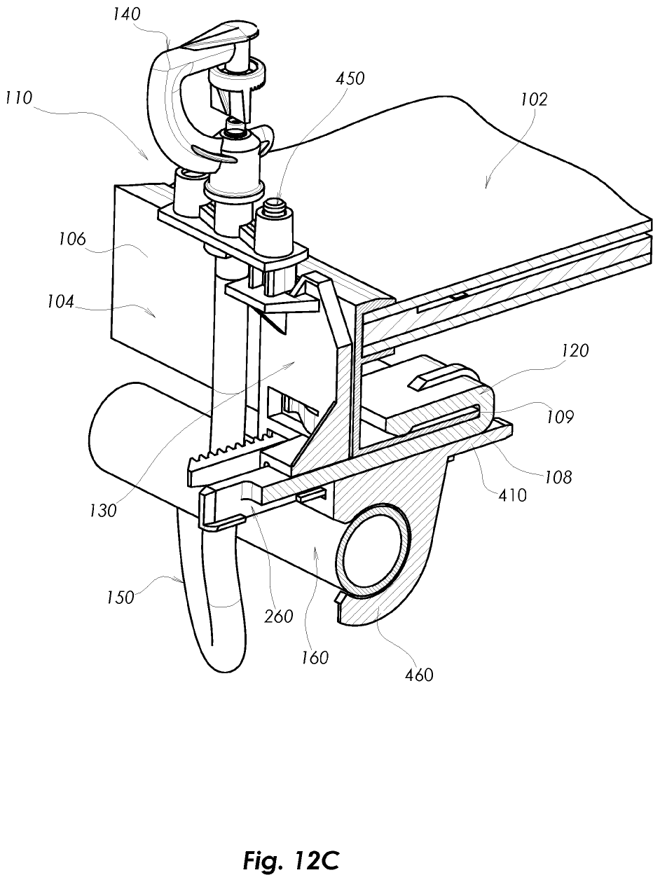

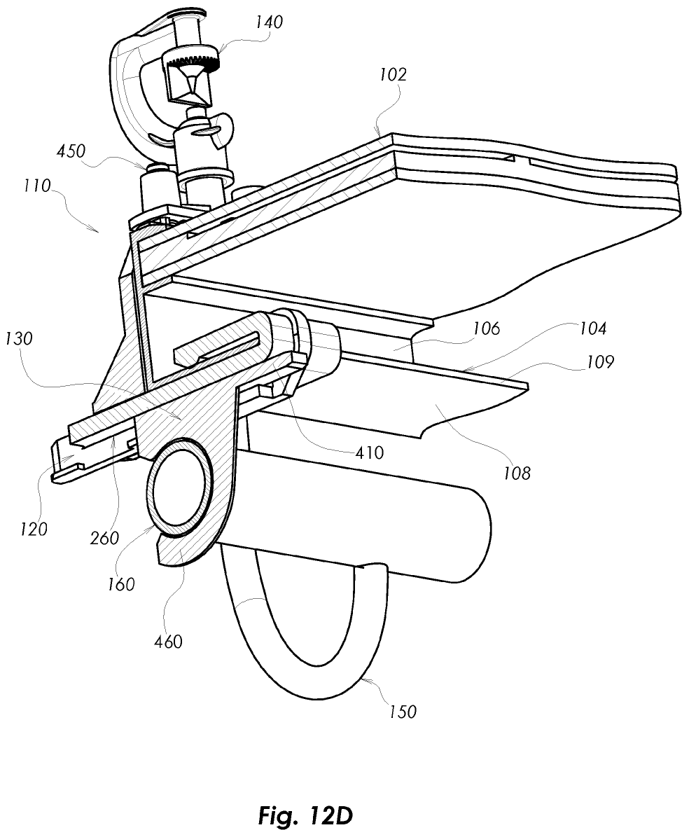

Reference is now made to FIGS. 12A-12D, which are simplified illustrations of a portion of a fully assembled self-cleaning solar panel assembly constructed and operative in accordance with a preferred embodiment of the present invention. As seen in FIGS. 12A-12D, a sprayer 140 is mounted on a sprayer mounting pin 450 and is coupled via a supply hose 150 to a cleaning liquid manifold 160, which is retained on water supply tube mounting hook portion 460, which is sized to slidably retain cleaning liquid manifold 160 in engagement with frame 104.

It will be appreciated by persons skilled in the art that the present invention is not limited by what has been particularly shown and described hereinabove. Rather the scope of the present invention includes both combinations and subcombinations of features which are described hereinabove as well as modifications and variations thereof, which are not in the prior art.

1. A self-cleaning solar panel assembly comprising:
a solar panel assembly having a peripheral frame;
at least one sprayer mount assembly removably attachable to said peripheral frame, each of said at least one sprayer mount including a first element and a second element, both separate from said peripheral frame, said first element and said second element being removably joined together for clamping onto said peripheral frame; and
at least one sprayer mountable onto said at least one sprayer mount assembly.

2. A self-cleaning solar panel for assembly according to claim 1 and wherein said at least one sprayer mount assembly is retrofittable onto said solar panel assembly.

3. A self-cleaning solar panel assembly according to claim 1 and wherein said at least one sprayer is adapted to receive a cleaning liquid via a supply hose from a cleaning liquid manifold, which in turn is preferably mounted onto plural ones of said sprayer mount assemblies.

4-5. (canceled)

6. A self-cleaning solar panel assembly according to claim 1 and wherein said first element comprises a pair of flexible ratcheted arms and a central support and guiding finger for adjustable engagement with said second element thereby to accommodate various sizes of said peripheral frame.

7. A self-cleaning solar panel assembly according to claim 6 and wherein each of said flexible ratcheted arms is manually squeezable towards each other for enabling manual disengagement of the first and second elements from each other and from said peripheral frame.

8. A self-cleaning solar panel assembly according to claim 6 and wherein said second element comprises a main generally planar portion and a secondary generally planar portion extending generally perpendicularly thereto, said main generally planar portion comprising:
a pair of mutually spaced apertures each of which is formed with a tooth engagement wall portion, for engagement with ratchet teeth of said ratcheted arms of said first element; and
a main aperture which is configured to slidably receive said central support and guiding finger of said first element.

9. A self-cleaning solar panel assembly according to claim 8 and wherein said main generally planar portion is formed with a pair of resilient fingers, which provide press fit engagement with a peripheral wall portion of said peripheral frame.

10-11. (canceled)

12. A self-cleaning solar panel assembly comprising:
a solar panel assembly having a peripheral frame;
at least one retrofit sprayer mount removably attachable to said peripheral frame, each of said at least one retrofit sprayer mount including a frame engagement portion and a sprayer mounting portion, separate from said frame engagement portion, said frame engagement portion and said sprayer mounting portion being arranged for secure clamping onto said peripheral frame; and
at least one sprayer mountable onto said at least one retrofit sprayer mount assembly.

13. A self-cleaning solar panel assembly according to claim 12 and wherein said frame engagement portion and said sprayer mounting portion are selectably positionable for clamping onto said peripheral frame.

14. A self-cleaning solar panel assembly according to claim 12 and wherein said at least one sprayer is adapted to receive a cleaning liquid via a supply hose from a cleaning liquid manifold, which in turn is preferably mounted onto plural ones of said sprayer mount assemblies.

15. A self-cleaning solar panel assembly according to claim 12 and wherein said frame engagement portion comprises a partially folded-over portion which defines a slot removably but snugly receiving an inner-facing flange of said peripheral frame.

16. A self-cleaning solar panel assembly according to claim 15 and wherein said slot comprises an end wall, which engages an inner-facing edge of an inner-facing flange of said peripheral frame.

17-21. (canceled)

22. For use with a solar panel assembly having a peripheral frame, a sprayer mount assembly comprising:
a frame engagement portion; and
a sprayer mounting portion, separate from said frame engagement portion, said frame engagement portion and said sprayer mounting portion being removably joinable together for clamping onto said peripheral frame.

23-27. (canceled)

28. A sprayer mount assembly according to claim 22 and wherein said frame engagement portion and said sprayer mounting portion are selectably positionable for clamping onto said peripheral frame.

29. (canceled)

30. A sprayer mount assembly according to claim 22 and wherein said frame engagement portion comprises a partially folded-over portion which defines a slot removably but snugly receiving an inner-facing flange of said peripheral frame.

31. A sprayer mount assembly according to claim 30 and wherein said slot comprises an end wall, which engages an inner-facing edge of an inner-facing flange of said peripheral frame.

32. A sprayer mount assembly according to claim 22 and wherein said frame engagement portion comprises a pair of flexible ratcheted arms and a central support and guiding finger for adjustable engagement with said sprayer mounting portion thereby to accommodate various sizes of said peripheral frame.

33. A sprayer mount assembly according to claim 32 and wherein each of said flexible ratcheted arms is manually squeezable towards each other for enabling manual disengagement of the frame engagement portion and said sprayer mounting portion from each other and from said peripheral frame.

34. A sprayer mount assembly according to claim 32 and wherein said sprayer mounting portion comprises a main generally planar portion and a secondary generally planar portion extending generally perpendicularly thereto, said main generally planar portion comprising:
a pair of mutually spaced apertures each of which is formed with a tooth engagement wall portion, for engagement with ratchet teeth of said ratcheted arms of said frame engagement portion; and
a main aperture which is configured to slidably receive a central support and guiding finger of said frame engagement portion.

35. A sprayer mount assembly according to claim 34 and wherein said main generally planar portion is formed with at least one resilient finger, which provides press fit engagement with a peripheral wall portion of said peripheral frame.

36. (canceled)
